(19) United States
(12) Patent Application Publication
(10) Pub. No.: US 2026/0360349 A1
(43) Pub. Date: Nov. 12, 2026

(54) Generative Audio Processing and Generation

(71) Applicant: Google LLC, Mountain View, CA (US)

(72) Inventors: Clement Dickinson Wright, Los Angeles, CA (US); Sarah Fay Smith, San Francisco, CA (US); Daniel Paik, San Francisco, CA (US); Rosemary Margaret La Prairie, London (GB)

(21) Appl. No.: 19/200,371

(22) Filed: May 6, 2025

(51) Int. Cl. G10L 13/027; G06F 3/0484; G06F 16/635; G10L 13/033; G10L 15/02

(52) U.S. Cl. CPC G10L 13/027; G06F 16/635; G10L 13/033; G10L 15/02; G06F 3/0484

(57) ABSTRACT

Methods, systems, devices, and non-transitory computer readable media for processing generative audio content are provided. The disclosed technology can include receiving content data associated with content. Inputs associated with the content can be received. Contexts associated with the content or the inputs can be determined. Based on inputting the content data, context data associated with the contexts, and input data associated with the inputs into one or more machine-learned models, generative audio data comprising synthetic language audio segments associated with the content data and the context data can be generated. The one or more machine-learned models can be configured to generate the generative audio based on processing features of the content data and the context data. Further, based on the generative audio data, audio indications associated with the synthetic language audio segments can be generated via an audio-output device.

### FIELD

The present disclosure relates generally to generating and processing generative audio. In particular, the present disclosure relates to using machine-learned models to generate generative audio based on a combination of content, context associated with the content, and detected inputs.

### BACKGROUND

Machine-learned models can be used to generate various forms of content. The resources involved in generating this content can vary based on the size and complexity of the content as well as the instructions that are used to direct the machine-learned models. A greater level of complexity or amount of content can result in a greater use of computational resources. Further, even detailed instructions can result in output that is not sufficient. However, increasing the computational resources can be expensive and reducing the complexity of instructions can result in suboptimal results. As such, attempting to improve the performance of computing systems that process content and the instructions associated with the content can present challenges. Accordingly, there may be different approaches to processing content and the instructions associated with the content.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of processing generative audio content. The computer-implemented method can comprise receiving, by a computing system comprising one or more processors, content data associated with content comprising one or more content modalities. The computer-implemented method can include receiving, by the computing system, one or more inputs associated with the content. The computer-implemented method can include determining, by the computing system, one or more contexts associated with the content or the one or more inputs. The computer-implemented method can include generating, by the computing system, based on inputting the content data, context data associated with the one or more contexts, and input data associated with the one or more inputs into one or more machine-learned models, generative audio data comprising one or more synthetic language audio segments associated with the content data, the context data, and the input data. The one or more machine-learned models can be configured to generate the generative audio based on processing one or more features of the content data, the context data, and/or the input data. The computer-implemented method can include generating, by the computing system, based on the generative audio data, via an audio-output device, one or more audio indications associated with the one or more synthetic language audio segments.

Another example aspect of the present disclosure is directed to one or more tangible non-transitory computer-readable media storing computer-readable instructions that when executed by one or more processors cause the one or more processors to perform operations. The operations can comprise receiving content data associated with content comprising one or more content modalities. The operations can include receiving one or more inputs associated with the content. The operations can include determining one or more contexts associated with the content or the one or more inputs. The operations can include generating, based on inputting the content data, context data associated with the one or more contexts, and input data associated with the one or more inputs into one or more machine-learned models, generative audio data comprising one or more synthetic language audio segments associated with the content data, the context data, and the input data. The one or more machine-learned models can be configured to generate the generative audio based on processing one or more features of the content data, the context data, and/or the input data. The operations can include generating, based on the generative audio data, via an audio-output device, one or more audio indications associated with the one or more synthetic language audio segments.

Another example aspect of the present disclosure is directed to a computing system comprising: one or more processors; one or more non-transitory computer-readable media storing instructions that when executed by the one or more processors cause the one or more processors to perform operations. The operations can comprise receiving content data associated with content comprising one or more content modalities. The operations can include receiving one or more inputs associated with the content. The operations can include determining one or more contexts associated with the content or the one or more inputs. The operations can include generating, based on inputting the content data, context data associated with the one or more contexts, and input data associated with the one or more inputs into one or more machine-learned models, generative audio data comprising one or more synthetic language audio segments associated with the content data, the context data, and the input data. The one or more machine-learned models can be configured to generate the generative audio based on processing one or more features of the content data, the context data, or the input data. The operations can include generating, based on the generative audio data, via an audio-output device, one or more audio indications associated with the one or more synthetic language audio segments.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

FIG. 1 depicts a block diagram of examples of operations performed by a generative audio computing system according to example embodiments of the present disclosure;

FIG. 2 depicts an example of a computing device according to example embodiments of the present disclosure;

FIG. 3 depicts an example of an interface for processing generative audio data based on selection of a portion of an image according to example embodiments of the present disclosure;

FIG. 4 depicts an example of an interface for processing generative audio data based on a browsing history according to example embodiments of the present disclosure;

FIG. 5 depicts an example of an interface for processing generative audio data based on a playlist according to example embodiments of the present disclosure; and

FIG. 6 depicts an example of an interface for processing generative audio data based on selection of a portion of text according to example embodiments of the present disclosure;

FIG. 7 depicts a flow chart diagram of an example method of processing generative audio according to example embodiments of the present disclosure;

FIG. 8 depicts a flow chart diagram of an example method of processing generative audio according to example embodiments of the present disclosure;

FIG. 9 is a flow chart diagram illustrating an example method for training a machine-learned model according to example implementations of aspects of the present disclosure;

FIG. 10 is a block diagram of an example processing flow for using machine-learned model(s) to process input(s) to generate output(s) according to example implementations of aspects of the present disclosure;

FIG. 11 is a block diagram of an example sequence processing model according to example implementations of aspects of the present disclosure;

FIG. 12 is a block diagram of an example technique for populating an example input sequence for processing by a sequence processing model according to example implementations of aspects of the present disclosure;

FIG. 13 is a block diagram of an example model development platform according to example implementations of aspects of the present disclosure;

FIG. 14 is a block diagram of an example training workflow for training a machine-learned model according to example implementations of aspects of the present disclosure;

FIG. 15 is a block diagram of an inference system for operating one or more machine-learned model(s) to perform inference according to example implementations of aspects of the present disclosure;

FIG. 16 is a block diagram of an example networked computing system according to example implementations of aspects of the present disclosure;

FIG. 17 is a block diagram of an example computing device according to example implementations of aspects of the present disclosure; and

FIG. 18 is a block diagram of an example computing device according to example implementations of aspects of the present disclosure.

### DETAILED DESCRIPTION

In general, the present disclosure is directed to generating generative audio data (e.g., a podcast) based on the detection, recognition, and/or classification of features (e.g., visual features and/or textual features) in content data that can comprise various content modalities (e.g., images, text, audio, and/or video). Further, the generative audio data can be automatically generated based on content, one or more contexts associated with the content, and/or inputs associated with the content. The inputs can comprise specific instructions (e.g., a prompt to indicate the type of generative audio to generate) or less direct guidance (e.g., encircling a portion of an image to indicate the content on which to base the generative audio).

In some embodiments, he disclosed technology can implement machine-learned models (e.g., generative machine-learned models that can comprise transformer models and/or diffusion models) that have been configured and/or trained to generate the generative audio data based on the detection, recognition, and/or classification of features of the content, context, and/or inputs. Further, the machine-learned models can be configured and/or trained to determine a tone and/or format of the generative audio based on the content, context, and/or inputs.

For example, a computing system can receive content data that is associated with content. The content can comprise images, text segments, audio segments, video segments, and/or audio-video segments. For example, the content can comprise a news article about a recent event. The computing system can then receive one or more inputs associated with the content. For example, the one or more inputs can be based on selecting (e.g., touching) content that is displayed on a touchscreen display device of a smartphone. Further, the computing system can determine one or more contexts associated with the content data and/or the one or more inputs. For example, the computing system can retrieve a search history associated with the content data (e.g., the webpages that were visited before and/or after visiting the web page comprising the content data).

The content data including the news article, context data based on the one or more contexts that were determined (e.g., the search history), and/or input data based on the inputs (e.g., touching a portion of the news article) can be inputted into a machine-learned model, that can generate generative audio data that can comprise one or more audio segments (e.g., one or more synthetic language audio segments). The one or more machine-learned models can be configured and/or trained to generate the generative audio data based on the detection, recognition, and/or classification of features of the content data, the context data, and/or the input data. For example, the one or more machine-learned models can be configured and/or trained to detect, recognize, classify, and/or parse textual features in the news article, parse text in the context data, determine that the input is associated with selecting a portion of the news article, and/or determine relationships between the content data, context data, and/or input data.

The disclosed technology can then, based on the generative audio data, generate one or more audio indications via an audio output device (e.g., loudspeakers). For example, the disclosed technology can comprise a computing device (e.g., a smartphone) that is configured to generate a podcast in which a synthetic host and a synthetic guest discuss the event described in the news article. As such, the disclosed technology allows for the generation of generative audio data that may be used in a variety of applications including audio playback applications, social media applications, online forum applications, and/or various other types of applications. Further, the disclosed technology can assist a user in more effectively performing the technical task of generating and/or processing generative audio data by means of a continued and/or guided human-machine interaction process in which various types of content (e.g., images, text, video segments, video segments, and/or audio-video segments) is received, contexts and inputs are processed, and generative audio data is generated in real-time based on continuously updated content data, context data, and/or input data.

The disclosed technology can be implemented in a computing system (e.g., a generative audio computing system) that is configured to access data and/or perform operations on the data. For example, the operations performed by the computing system can comprise receiving content data, receiving one or more inputs, determining one or more contexts associated with the content or the one or more inputs, generating generative audio data, and generating one or more synthetic language audio segments via an audio output device. Further, the computing system can leverage one or more machine-learned models that have been configured and/or trained to process (e.g., detect, recognize, and/or classify) content data, input data, and/or context data and generate generative audio data comprising one or more synthetic language audio segments based on one or more features of the content data, input data, and/or context data.

The computing system can be included as part of a system that includes a server computing device that receives data (e.g., content data comprising images, text, audio segments, and/or video segments) from a user's client computing device, performs operations based on the data and sends output comprising generative audio data back to the client computing device. In some embodiments, the computing system can include specialized hardware and/or software that enables the performance of operations specific to the disclosed technology. For example, the computing system can include one or more application specific integrated circuits and/or neural processing units that are configured to perform operations associated with the detection, recognition, and/or classification of content data comprising images, text, audio, and/or video; and/or the generation of generative audio data that comprises synthetic language audio segments and is based on content data, input data, and/or context data.

The computing system can receive, access, and/or retrieve content data. The content data can comprise content. Further, the content can be associated with one or more content modalities. For example, the content data can comprise one or more images, one or more text segments, one or more audio segments, one or more video segments, and/or one or more audio-video segments. For example, the content data can comprise one or more text segments, one or more images, and/or one or more video segments from an article on a website and/or a document. By way of further example, the content data can comprise video from a website such as a streaming video website. The content data can comprise content from a plurality of different time intervals (e.g., content that was retrieved on different days or at different times of the same day) and/or content associated with a plurality of search sessions (e.g., content that was retrieved from different search sessions that can include local search sessions and/or Internet search sessions.

The content data can comprise and/or be associated with information (e.g., metadata) that can be used to determine context associated with the content data. For example, the content data can comprise location data that can indicate geographic coordinates of a computing device that is used to consume (e.g., view or listen to) content data.

The computing system can receive, detect, and/or recognize one or more inputs. The one or more inputs can be associated with the content. Further, the one or more inputs can be used to select one or more portions of the content. For example, the one or more inputs can be used to select one or more portions of one or more text segments, one or more images, one or more video segments, one or more audio segments, and/or one or more audio-video segments. In some embodiments, the one or more inputs can comprise one or more prompts (e.g., one or more text-based prompts). For example, the computing system can generate one or more text-based prompts based on detecting one or more inputs to one or more input devices (e.g., a keyboard, touchscreen, camera, and/or a microphone) associated with the computing system. The one or more prompts can be used as input to the one or more machine-learned models that are configured and/or trained to generate the generative audio data. Further, the one or more machine-learned models can be configured to generate the generative audio data based on detection, recognition, and/or classification of one or more features of the one or more text-based prompts. In some embodiments, the computing system can generate input data based on the one or more inputs.

In some embodiments, the one or more inputs can comprise one or more tactile inputs that can be associated with one or more portions of the content data comprising an image displayed on a display device configured to display the content. For example, the one or more tactile inputs can be used to select portions of an image or text that is displayed on a touchscreen display device. Further, the one or more machine-learned models can be configured to generate the generative audio data based on detection, recognition, or classification of one or more features of the one or more portions of the content data associated with the one or more tactile inputs.

In some embodiments, the one or more tactile inputs can comprise tapping the one or more portions of the content data comprising the image displayed on a display device. For example, a portion of text displayed on a display device can be tapped to indicate that the portion of text comprises relevant content that can be used as an input to the one or more machine-learned models and used to generate the generative audio data. The one or more tactile inputs can comprise encircling the one or more portions of the content data comprising an image displayed on the display device. For example, a portion of an image displayed on a display device can be encircled to indicate the relevance of the content within the encircled region. Further, the one or more tactile inputs can comprise swiping the one or more portions of the content data comprising an image associated with audio that is displayed on the display device. For example, a portion of an image comprising an interface element (e.g., a graphical use interface element) that indicates an audio segment (e.g., a song or interview) and is displayed on a display device can be swiped to indicate that the audio segment has been selected and can be used as an input to the one or more machine-learned models.

In some embodiments, the one or more inputs can comprise one or more speech-based prompts that can be associated with the content data. For example, the one or more speech based prompts can be based on detection and/or recognition of a human voice that is translated into text. Further, the one or more machine-learned models can be configured to generate the generative audio data based on detection, recognition, or classification of one or more features of the one or more speech-based prompts. For example, the one or more machine-learned models can

The computing system can determine one or more contexts. The one or more contexts can be associated with the content data and/or the one or more inputs. The computing system can determine the one or more contexts based on processing the content data, data associated with the one or more contexts, and/or data associated with the one or more inputs. For example, the computing system can access the content data and retrieve metadata that is included in the content data. The metadata can comprise information including an author associated with a text segment from an article, the photographer associated with an image, the composer of an audio segment (e.g., a song) and/or a webpage associated with a video segment. In some embodiments, the computing system can generate context data based on the one or more contexts.

Further, the one or more contexts can comprise information associated with an application, a search history, location data, and/or one or more time intervals. For example, the computing system can access an application that is associated with the content data (e.g., a web browser that displays content, a music player application that plays audio segments, an image viewer application, and/or a document viewer application). The application can send information comprising one or more contexts that indicate one or more entities associated with the content data (e.g., the owner of a website or the author of a document) that can be used to generate the generative audio. For example, the author associated with a text segment can be used to retrieve additional content (e.g., additional documents written by the same author). By way of further example, the computing system can access a search history that is associated with the content data and determine the one or more contexts based on the search history. The search history can comprise a list of search queries, visited webpages, and/or search results that may be associated with the content data. For example, the search history can be used to retrieve additional content such as webpages that are regularly visited and which may comprise links to additional content.

Additionally, the computing system can determine the one or more contexts based on location data, which can indicate a location of the computing device on which the content data is consumed (e.g., viewed or listened to). For example, the location data can be used to determine one or more contexts that indicate that the computing device used to consume the content data is in a vehicle or the user's home. If the one or more contexts indicate that the user is in a vehicle, the one or more contexts may be used to determine a duration (e.g., a playback time) associated with the generative audio based on an estimated travel time. Further, the one or more contexts can be based on temporal data. For example, the time of day during which the content data is consumed can be used to determine the volume of the generative data (e.g., a lower volume in the evening) or the tempo of the synthetic language audio segments (e.g., a slower tempo in the evening and a faster tempo in the morning).

In some embodiments, the computing system can determine the one or more contexts based on biographical data that can indicate a user's age or reading comprehension level. Further, the one or more machine-learned models can be configured and/or trained to generate the generative audio data based on the user's age or reading comprehension level. For example, the biographical data can comprise an age or age range associated with a user. The age or age range can be used as an input to the one or more machine-learned models, which can generate content that meets certain age criteria. For example, if the biographical data indicates that a user is a ten year old girl, the generative audio data that is generated can use simpler language, abstain from profanity, and include references that a ten year old girl may be familiar with (e.g., children's animated film characters). Further, if the biographical data indicates that the content is in a different language from the user's native language, the one or more machine-learned models can be configured and/or trained to generate generative audio that is translated into the user's native language. Further, if the user has a low level of reading comprehension, the one or more machine-learned models can be configured and/or trained to generate generative audio at a reading comprehension level that corresponds to the reading comprehension level of the user.

The computing system can generate generative audio data. The generative audio data can comprise one or more audio segments. The one or more audio segments can comprise one or more synthetic language audio segments. Further, the generative audio data can be based on the content data, context data associated with the one or more contexts, and/or input data associated with the one or more inputs. The one or more synthetic language audio segments can be associated with one or more portions of speech. For example, the one or more synthetic language audio segments can be associated with or correspond to one or more words (e.g., each synthetic language audio segment corresponds to an individual word), one or more portions of words (e.g., each synthetic language audio segment corresponds to a portion of a word such as a prefix, suffix, or root word), and/or one or more audio waveforms (e.g., an audio waveform comprising a representation of an amplitude and frequency of sound over time). In some embodiments, the generative audio data can comprise information that indicates the volume of a portion of the generative audio data (e.g., loud, quiet, or some volume in decibels). Further, the one or more audio segments that can comprise audio segments that are not associated with language and/or speech. For example, the generative audio data can comprise one or more audio segments that are associated with music, sound effects, the sounds of nature (e.g., the sound of waves on a beach), animal sounds (e.g., a lion's roar, a dog's bar, or a cat's meow), and/or mechanical sounds (e.g., the sound of an automobile).

In some embodiments, the one or more synthetic language audio elements can comprise and/or be based on one or more tokens. The one or more tokens can be based on output from the one or more machine-learned models, which can be configured and/or trained to generate the one or more tokens based on input comprising the content data, the context data, and/or the input data.

The one or more synthetic language audio segments of the generative audio data can comprise segments of synthetic speech that is generated by the computing system. The one or more synthetic language audio segments can be generated based on inputting the content data, the context data, and/or the one or more inputs into one or more transformer models and/or one or more diffusion models that are configured and/or trained to generate human sounding speech. In some embodiments, the one or more machine-learned models can generate text data (e.g., a script) associated with the content and/or context, which is then further processed by the one or more machine-learned models to generate the generative audio data.

The computing system can generate generative audio data that can comprise different types of audio formats that use one or more synthetic speakers associated with the one or more synthetic language audio segments. For example, the generative audio data can comprise a single speaker (e.g., a narrator or a speaker that provides a monologue) or a plurality of speakers (e.g., a host that asks questions and an expert that answers the questions). Further, the generative audio can comprise different ways of providing information including a recap format (e.g., a format similar to a broadcast news) in which information is summarized and provided in short segments that may not be related to one another, an educational format in which a concept (e.g., a scientific concept or an economic concept) or one or more events (e.g., current events and/or historical events) are discussed or explained, a fictional format in which a work of fiction that can comprise multiple characters with different voices and accompanied by sound effects is generated, a documentary format in which one or more events are discussed and/or described, a panel of experts format in which different experts discuss a subject associated with the content, and/or an interview format in which there is a guest and a host that asks questions of the guest.

In some embodiments, the generative audio data can comprise one or more podcasts. The one or more podcasts can be associated with the content data, the context data, and/or the input data. For example, the content data can comprise an image of a polar bear and the generative audio data can comprise a podcast that describes the migratory habits of polar bears and includes a discussion between a synthetic host and a synthetic biologist that studies polar bears.

Generating the generative audio data can be based on inputting the content data, the context data, and/or the one or more inputs into one or more machine-learned models. The one or more machine-learned models can be configured and/or trained to process one or more features of the content data, context data, and/or input data. For example, the one or more machine-learned models can detect, recognize, and/or classify one or more features of the content data, the context data, and/or the one or more inputs.

In some embodiments, the one or more machine-learned models can comprise one or more audio diffusion models, one or more transformer models, and/or one or more autoencoder models. Further, the one or more machine-learned models can comprise one or more retrieval augmented generation (RAG) models. The one or more RAG models can be configured to perform one or more searches of one or more content sources based on the content data, context data, and/or input data. The one or more machine-learned models can search one or more documents, one or more web sites, one or more image repositories, one or more video repositories, and/or one or more audio repositories (e.g., audio repositories comprising podcasts, news, and/or music). Further, the one or more machine-learned models can be configured and/or trained to retrieve additional content data that is based on the one or more searches. For example, the one or more machine-learned models can retrieve additional content from webpages that include additional content that is associated with the content. Further, if the content comprises an image of a piece of artwork (e.g., an image of a painting or sculpture), the one or more machine-learned models can recognize the artwork and/or retrieve documents that comprise text segments associated with the content comprising the artwork.

In some embodiments, the additional content can include content that is not included in the content data. For example, if the content comprises an article about a sports team (e.g., a hockey team), the additional content may comprise a different article about the same sports team. Further, the one or more machine-learned models can be configured to generate the generative audio data based in part on the additional content data. For example, if the content comprises

In some embodiments, the one or more machine-learned models can be configured to determine, based on the content data, the context data, and/or the input data, a tone (e.g., serious tone or humorous tone), a tempo (e.g., a reading rate in words per minute), or a reading comprehension level (e.g., a complexity of vocabulary and/or grammatical structure) for the generative audio data. Further, the one or more machine-learned models can be configured and/or trained to generate the generative audio data based on the tone, the tempo, and/or the reading comprehension level of the content data, the context data, or the input data. For example, based on one or more inputs that indicate a user is a child (e.g., a speech input that indicates a child's voice) the one or more machine-learned models can generate generative audio that is less complex and more suited to a child. Further, the one or more machine-learned models can generate generative audio that is outputted at a slower tempo and the synthetic voice that is outputted can be configured to sound less serious.

In some embodiments, a tempo of the one or more audio segments can be based on the content data, the input data, and/or the context data. For example, context data can comprise information associated with a user's listening preferences which can indicate a preference for lower tempo music and the synthetic language audio segments can have a lower tempo based on the user's listening preferences.

The one or more machine-learned models can be configured and/or trained to perform one or more object processing operations to detect, recognize, and/or classify one or more objects in the content data (e.g., content data comprising one or more images, one or more video segments, and/or one or more audio-video segments). The one or more machine-learned models can be configured and/or trained to generate the generative audio data based in part on the detection, recognition, and/or classification of one or more objects in the content data. For example, the one or more machine-learned models can detect, recognize, and/or classify artificial structures, natural structures, plants, animals, people, vehicles, clothing, instruments, and/or furniture in content data. By way of further example, the one or more machine-learned models can recognize a building in an image and generate generative audio based on recognition of the building.

The computing system can determine one or more amounts of unallocated time (e.g., unallocated time that is available to a user associated with the one or more inputs). Determination of the one or more amounts of unallocated time can be based on the one or more contexts. For example, the computing system can access context data based on one or more contexts comprising information from a calendar application associated with a user's computing device. The context data can be used to determine the unallocated time that is available to the user (e.g., the user has not allocated the time from 6:00 p.m. to 10:00 p.m.). In some embodiments, the context data can comprise a schedule of a user and/or one or more indications of an estimated travel time of the user from an initial location to a destination. For example, the context data can indicate that the user will arrive at work in thirty minutes.

The computing system can determine a duration (e.g., a playback time to output the one or more audio indications associated with the generative audio data) associated with the generative audio data based on the one or more amounts of unallocated time. For example, if the computing system determines that the amount of unallocated time is four hours, the computing system can generate generative audio that has a duration of less than four hours.

The computing system can generate one or more indications (e.g., one or more audio indications). Generation of the one or more indications (e.g., the one or more audio indications) can be based on the generative audio data. For example, the computing system can receive generative audio data comprising information that indicates a script for a podcast, the synthetic voices that generate audio indications (e.g., audio indications that are generated via one or more audio output devices and are audible) of different portions of the script, the time intervals during which the synthetic voices generate the audible indications, the volume of the one or more indications at different time intervals, sound effects and/or music that is generated during playback of the generative audio data, or a vocal tone and/or tempo of the one or more synthetic voices (e.g., a pitch and/or reading speed). The computing system can then generate one or more indications (e.g., one or more audio indications) that are based on the generative audio data. For example, if the generative audio data indicates a first synthetic voice that is low pitched, has a particular tempo, and generates the words “IN THE BLINK OF AN EYE,” then the one or more indications that are outputted by the audio output device can indicate “IN THE BLINK OF AN EYE” in a matching low pitch and at the tempo indicated in the generative audio data.

Further, the one or more audio indications can be associated with and/or correspond to the one or more audio segments (e.g., the one or more synthetic language audio segments). Further, the one or more audio indications can be generated via an audio output device. For example, based on one or more audio segments that correspond to text, the computing system can perform text to speech operations (e.g., text to speech operations performed by the one or more machine-learned models) and generate the one or more audio indications via one or more loudspeakers (e.g., the loudspeakers of a smartphone or laptop computing device). By way of further example, based on one or more audio segments that correspond to waveforms, the computing system can perform operations to process the waveforms of the one or more audio segments and generate the one or more audio indications via one or more speakers.

The one or more machine-learned models can comprise one or more generative models (e.g., one or more transformer models, one or more diffusion models, and/or one or more autoencoder models) that are trained to generate the generative audio data based on input comprising training data. The training data can comprise a plurality of training inputs. The plurality of training inputs can comprise training content data, training context data, and/or training input data. The training content data can comprise a plurality of training images, a plurality of training text segments, a plurality of training audio segments, a plurality of training video segments, a plurality of training audio-video segments, a plurality of training inputs, and/or a corresponding plurality of ground-truth audio segments. The training context data can comprise a plurality of training locations, a plurality of training search histories, a plurality of training websites, a plurality of training applications, a plurality of training search results, and/or a plurality of training search queries. Further, the training input data can comprise a plurality of training inputs (e.g., tactile inputs, speech inputs, and/or text based inputs).

In some embodiments, the training data can comprise a plurality of embeddings. The plurality of embeddings can comprise a lower-dimensional vector space representation of the training data. For example, training audio segments can be represented in a lower-dimensional vector space that can preserve key features of the audio segments in a smaller dimensional vector space than the higher-dimensional vector space of the original audio segments (e.g., an audio embedding can comprise a lower-dimensional vector space in which the audio segments are compressed, noise is reduced, and/or redundant audio segments are removed). The plurality of embeddings can be arranged such that semantically similar content is closer together in the vector space. The plurality of embeddings can be generated based on the training content data, training context data, and/or training input data. For example, the plurality of embeddings can comprise training audio embeddings that are generated based on inputting the training audio data into one or more machine-learned models that are configured and/or trained to generate the plurality of training audio embeddings.

The one or more machine-learned models can be trained to generate and/or determine one or more audio preferences of a user based on training data comprising a plurality of training audio segments of a user associated with the content data. Further, the one or more machine-learned models can be configured to determine the one or more synthetic language audio segments based on the one or more audio preferences. For example, the one or more machine-learned models can determine that a user prefers a lower pitched synthetic voice, a faster cadence or tempo of speech, and/or a certain amount of pauses between portions of speech. The training data can be used after receiving the express consent of the user and after notifying the user that the training data can be used to train one or more machine-learning models.

In some embodiments, the one or more machine-learned models can be configured and/or trained based on training data that can comprise training content data, training context data, training input data, and/or a corresponding plurality of portions of ground-truth generative audio data. The plurality of portions of ground-truth generative audio data can comprise a plurality of audio segments that are relevant and/or appropriate with respect to corresponding training content data, training context, and/or training input data.

The training content data can comprise a plurality of training images, a plurality of training text segments, a plurality of training audio segments, a plurality of training video segments, and/or a plurality of training audio-video segments. The training context data can comprise a plurality of training applications, a plurality of training location data, a plurality of training search histories, and/or a plurality of time intervals associated with the training content data. The training input data can comprise a plurality of text-based training inputs, a plurality of speech-based training inputs, or a plurality of tactile-based training inputs.

Further, training the one or more machine-learned models can comprise generating and/or determining, based on inputting the training data into the one or more machine-learned model, a plurality of predicted portions of generative audio data. Based on the received input, the one or more machine-learned models can perform one or more operations and generate an output comprising a plurality of predicted portions of generative audio data associated with the corresponding plurality of training data inputs. The output of the one or more machine-learned models can then be evaluated based on one or more comparisons of the plurality of predicted portions of generative audio data to a corresponding plurality of portions of ground-truth generative audio data associated with the training data.

Training the one or more machine-learned models can comprise determining a loss based on one or more differences between the plurality of predicted portions of generative audio data and the plurality of portions of ground-truth generative audio data. In some embodiments, a loss function can be used to determine the loss. The loss function can be used to evaluate one or more differences between the plurality of predicted portions of generative audio data and the plurality of portions of ground-truth generative audio data. The loss can increase in proportion to a number of differences between the plurality of predicted portions of generative audio data and the plurality of portions of ground-truth generative audio data. For example, if there are ten differences between the plurality of predicted portions of generative audio data and the plurality of portions of ground-truth generative audio data, the loss can be greater than if there is one difference between the plurality of predicted portions of generative audio data and the plurality of portions of ground-truth generative audio data.

Further, the loss can increase in proportion to the magnitude of differences between the plurality of predicted portions of generative audio data and the plurality of portions of ground-truth generative audio data. For example, a portion of predicted generative audio data that is very different from a ground-truth portion of generative audio data can result in a greater loss than a portion of predicted generative audio data that is slightly different from a corresponding portion of ground-truth generative audio data.

Training the one or more machine-learned models can comprise modifying a plurality of parameters of the one or more machine-learned models to minimize the loss. The plurality of parameters can be associated with detection, recognition, and/or classification of one or more features of the training data that can be used to determine the portions of predicted generative audio data. Further, the plurality of parameters can be associated with a plurality of weights that can be associated with an extent to which the plurality of parameters contribute to determining the loss.

Training the one or more machine-learned models can be performed over a plurality of iterations. In each iteration of training, the weight of the plurality of parameters that contribute to increasing the loss can be reduced and/or the weight of the plurality of parameters that contribute to decreasing the loss can be increased. As a result, the plurality of weights of the plurality of parameters can be associated with the plurality of portions of predicted generative audio data such that parameters that are more heavily weighted can contribute more to determining the portions of predicted generative audio data than parameters that are less heavily weighted. Over the plurality of iterations, the weights of the plurality of parameters can be modified to minimize the loss until a threshold loss that corresponds to a high accuracy of the one or more machine-learned models determining the plurality of portions of predicted generative audio data is achieved. For example, the loss can be minimized until a threshold loss associated with 99% accuracy is achieved by the machine-learned model.

The systems, methods, devices, and/or computer-readable media (e.g., tangible non-transitory computer-readable media) in the disclosed technology can provide a variety of technical effects and benefits including an improvement in the effectiveness with which generative audio data is generated. In particular, the disclosed technology improves the efficiency of processing content data, context data, and input data by leveraging machine-learned models that are configured and/or trained to detect, recognize, and/or classify images, text segments, audio segments, video segments, and/or audio-video segments based on processing features (e.g., low-level audio features and/or low level visual features) of the content data, context data, and/or input data. Further, improved generation of generative audio data based on the detection, recognition, and/or classification of features of content data including images, audio, and/or video can improve the effectiveness with which computational resources are used by leveraging one or more machine-learned models that are able to determine features (e.g., visual features, text features, and/or audio features) more efficiently.

As such, the disclosed technology can allow the user of a computing system to perform the technical task of generating or processing generative audio data based on the detection, recognition, and/or classification of features of content data (e.g., images, text, audio, and/or video), context data, and/or input data. As a result, users are provided with the specific benefits of improved performance (classification performance and/or generative audio data generation performance) and more efficient use of system resources. Further, any of the specific benefits provided to users can be used to improve the effectiveness of a wide variety of devices and services including devices that use generative audio data. Accordingly, the improvements offered by the disclosed technology can result in tangible benefits to a variety of devices and/or systems including mechanical, electronic, and computing systems associated with generating and/or processing generative audio data.

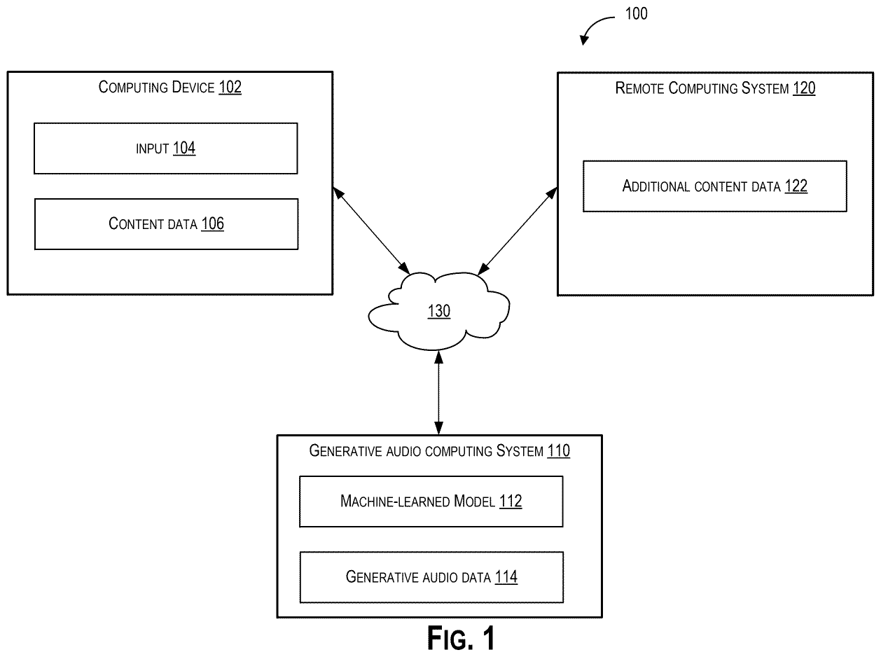

With reference now to the figures, example embodiments of the present disclosure will be discussed in further detail. FIG. 1 depicts a block diagram of examples of operations performed by a generative audio computing system according to example embodiments of the present disclosure. One or more operations described with respect to a system 100 can be executed and/or implemented on one or more computing devices or computing systems comprising, for example, the computing device 50, the server computing system 60, the model development platform system 70, and/or the computing device 200. Further, one or more portions of the operations described with respect to the system 100 can be executed or implemented as an algorithm on the hardware devices or systems disclosed herein.

A computing device 102 (e.g., a laptop computing device and/or a smartphone) can be used to generate the input 104 which can be associated with the content data 106. For example, the computing device 102 can execute an application (e.g., a social media application) that can receive an input 104. The input 104 can comprise a tactile input that can be used to select a portion of content associated with the content data (e.g., a user touching a display device to select an image). The computing device 102 can then process the input 104 and/or the content data 106 to determine one or more contexts associated with the input 104 and/or the content data 106. For example, the computing device 102 can determine one or more contexts comprising the type of application that was used to generate the content data 106 and/or the time at which the content associated with the content data 106 was accessed. The computing device 102 can then send, via the network 130, data comprising the context data, the content data 106, and/or input data based on the input 104 to the generative audio computing system 110.

The generative audio computing system 110 can receive the context data, the content data 106, and/or input data based on the input 104. The generative audio computing system 110 can implement one or more machine-learned models 112 (e.g., one or more LLMs configured and/or trained to generate the generative audio data 114). Based on inputting the context data, the content data 106, and/or input data based on the input 104 into the one or more machine-learned models 112, the one or more machine-learned models 112 can generate the generative audio data 114. The generative audio data 114 can comprise synthetic language audio segments. The synthetic language audio segments can comprise spoken audio such as a narrative and/or discussion about a topic associated with the content data 106. The generative audio computing system 110 can then send the generative audio data 114 to the computing device 102. Based on the generative audio data 114, the computing device 102 can output the synthetic language audio segments via an audio output device of the computing device 102.

In some embodiments, additional content data 122 can be stored in the remote computing system 120. The additional content data 122 can comprise content that is different from the content data 106 and can include one or more portions of the content data 106. The generative audio computing system 110 can access the additional content data 122 via the network 130. Further, in addition to the context data, the input data based on the input 104, and/or the content data 106, the generative audio computing system 110 can use the additional content data 122 as an input to the one or more machine-learned models 112.

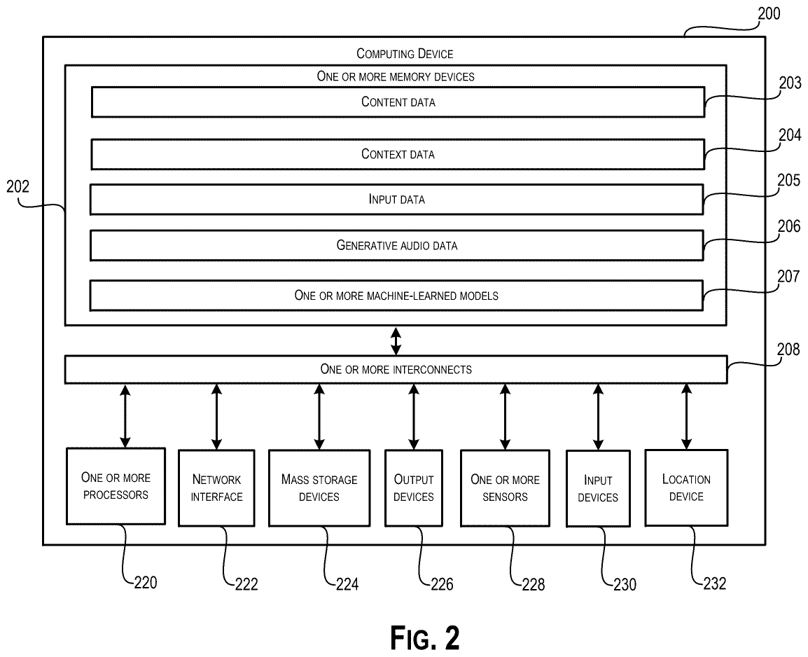

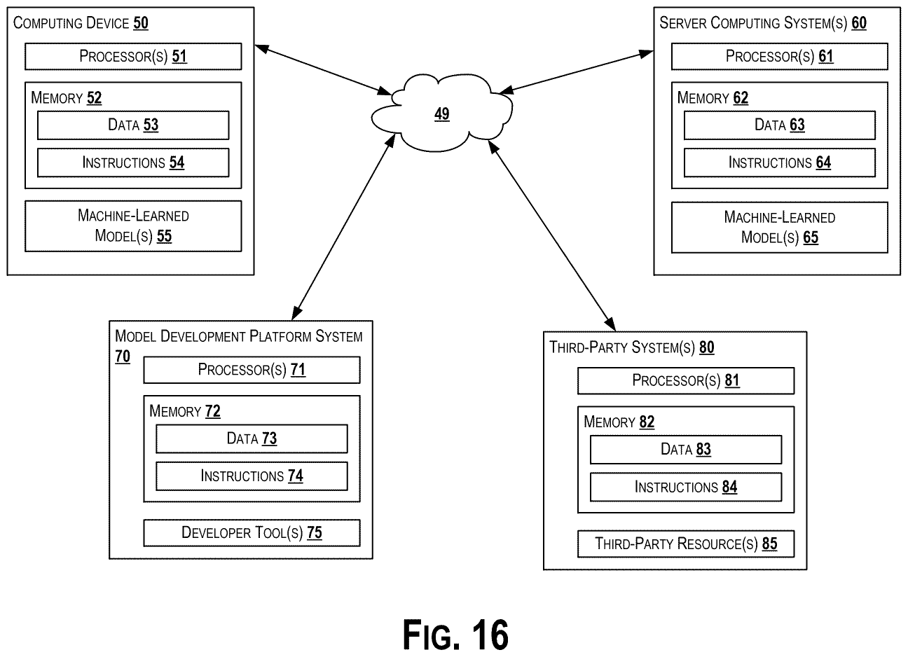

FIG. 2 depicts an example of a computing device according to example embodiments of the present disclosure. A computing device 200 can include one or more features and/or capabilities of the computing device 50, the server computing system 60, and/or the model development platform system 70. Furthermore, the computing device 200 can perform one or more actions and/or operations performed by the computing device 50, the server computing system 60, and/or the model development platform system 70, which are described with respect to FIG. 16.

As shown in FIG. 2, the computing device 200 (e.g., a generative audio processing device) can include one or more memory devices 202, content data 203, context data 204, input data 205, generative audio data 206, one or more machine-learned models 207, one or more interconnects 208, one or more processors 220, a network interface 222, one or more mass storage devices 224, one or more output devices 226, one or more sensors 228, one or more input devices 230, and/or the location device 232. The computing device 200 can be configured as a desktop computing device and/or a mobile computing device (e.g., a smartphone, tablet computing device, and/or laptop computing device). Further, the computing device 200 can process and/or generate data (e.g., generative audio data) based on other data (e.g., content data, context data, and/or input data) of the computing device 200 and/or data that is received from another computing device (e.g., content data, context data, and/or input data that is generated by a remote computing device).

The one or more memory devices 202 can store information and/or data (e.g., the content data 203, the context data 204, the input data 205, and/or the one or more machine-learned models 207). Further, the one or more memory devices 202 can include one or more computer-readable mediums (e.g., tangible non-transitory computer-readable media), including RAM, ROM, EEPROM, EPROM, flash memory devices, magnetic disks, and combinations thereof. The information and/or data stored by the one or more memory devices 202 can be executed by the one or more processors 220 to cause the computing device 200 to perform operations including receiving content data, receiving one or more inputs, determining one or more contexts associated with the content or the one or more inputs, generating generative audio data, and generating one or more synthetic language audio segments via an audio output device.

The content data 203 can include, be included in, and/or be associated with one or more portions of data (e.g., the data 53, the data 63, and/or the data 73, which are depicted in FIG. 16) and/or one or more instructions (e.g., the instructions 54, the instructions 64, and/or the instructions 74 which are depicted in FIG. 16) that are stored in the memory 52, the memory 62, and/or the memory 72, respectively. The content data 203 can comprise one or more images, one or more text segments, one or more audio segments, one or more video segments, and/or one or more audio-video segments. Further, the content data 203 can include and/or be included in one or more portions of the context data 204. In some embodiments, the content data 203 can be received from one or more computing systems (e.g., the computing device 50 and/or the server computing system 60 that is depicted in FIG. 16) which can include one or more computing systems that are remote from the computing device 200.

The context data 204 can include, be included in, and/or be associated with one or more portions of data (e.g., the data 53, the data 63, and/or the data 73, which are depicted in FIG. 16) and/or instructions (e.g., the instructions 54, the instructions 64, and/or the instructions 74 which are depicted in FIG. 16) that are stored in the memory 52, the memory 62, and/or the memory 72, respectively. The context data 204 can be associated with the content data 203 and/or comprise various types of context. For example, the context data 204 can comprise context associated with an application (e.g., a software application associated with the content), a location associated with the computing device 200, a time of day associated with the content data 203 and/or the input data 205, search results and/or a search history associated with the content data 203, and/or an event associated with the content data 203 (e.g., a calendar event). In some embodiments, one or more portions of the context data 204 can include and/or be included in the content data 203. In some embodiments, the context data 204 can be received from one or more computing systems (e.g., the server computing system 60 that is depicted in FIG. 16) which can include one or more computing systems that are remote from the computing device 200.

The input data 205 can include, be included in, and/or be associated with one or more portions of data (e.g., the data 53, the data 63, and/or the data 73, which are depicted in FIG. 16) and/or instructions (e.g., the instructions 54, the instructions 64, and/or the instructions 74 which are depicted in FIG. 16) that are stored in the memory 52, the memory 62, and/or the memory 72, respectively. Furthermore, the input data 205 can include information associated with an input and/or an input modality. For example, the input data 205 can comprise a text-based input (e.g., text comprising a prompt entered through an input device), a speech-based input (e.g., a voice command), and/or a tactile input (e.g., touching a touchscreen associated with a graphical user interface). In some embodiments, the input data 205 can be received from one or more computing systems (e.g., the server computing system 60 that is depicted in FIG. 16) which can include one or more computing systems that are remote from the computing device 200.

The generative audio data 206 can include, be included in, and/or be associated with one or more portions of data (e.g., the data 53, the data 63, and/or the data 73, which are depicted in FIG. 16) and/or instructions (e.g., the instructions 54, the instructions 64, and/or the instructions 74 which are depicted in FIG. 16) that are stored in the memory 52, the memory 62, and/or the memory 72, respectively. Furthermore, the generative audio data 206 can include information associated with the content data 203, the context data 204, and/or the input data 205. Further, the generative audio data can be based on output from the one or more machine-learned models 207 that is generated by using input comprising the content data 203, the context data 204, and/or the input data 205. For example, the generative audio data 206 can comprise a generative audio discussion (e.g., a podcast) based on a user input that indicated a portion of a photograph in a news article about one or more topics that are of interest to the user. In some embodiments, the generative audio data 206 can be received from one or more computing systems (e.g., the server computing system 60 that is depicted in FIG. 16) which can include one or more computing systems that are remote from the computing device 200.

The one or more machine-learned models 207 (e.g., the one or more machine-learned models 55, the one or more machine-learned models 65, and/or the machine-learned models 75) can include, be included in, and/or be associated with one or more portions of the data 53, the data 63, and/or the data 73 which are depicted in FIG. 16 and/or instructions (e.g., the instructions 54, the instructions 64, and/or the instructions 74 which are depicted in FIG. 16) that are stored in the memory 52, the memory 62, and/or the memory 72, respectively. Furthermore, the one or more machine-learned models 207 can be configured and/or trained to perform operations comprising receiving content data, receiving one or more inputs, determining one or more contexts associated with the content or the one or more inputs, generating generative audio data, and generating one or more synthetic language audio segments via an audio output device. In some embodiments, the one or more machine-learned models 207 can be received from one or more computing systems (e.g., the server computing system 60 that is depicted in FIG. 16) which can include one or more computing systems that are remote from the computing device 200.

The one or more interconnects 208 can include one or more interconnects or buses that can be used to send and/or receive one or more signals (e.g., electronic signals) and/or data (e.g., the content data 203, the context data 204, the input data 205, the generative audio data 206, and/or the one or more machine-learned models 207) between devices of the computing device 200, including the one or more memory devices 202, the one or more processors 220, the network interface 222, the one or more mass storage devices 224, the one or more output devices 226, the one or more sensors 228, and/or the one or more input devices 230. The one or more interconnects 208 can be arranged or configured in different ways, including parallel or serial connections. Further the one or more interconnects 208 can include one or more internal buses to connect the internal components of the computing device 200; and one or more external buses used to connect the internal components of the computing device 200 to one or more external devices. By way of example, the one or more interconnects 208 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 220 can include one or more computer processors that are configured to execute the one or more instructions stored in the one or more memory devices 202. For example, the one or more processors 220 can, for example, include one or more general purpose central processing units (CPUs), application specific integrated circuits (ASICs), neural processing units (NPUs), and/or one or more graphics processing units (GPUs). Further, the one or more processors 220 can perform one or more actions and/or operations including one or more actions and/or operations associated with the content data 203, the context data 204, the input data 205, the generative audio data 206, and/or the one or more machine-learned models 207. The one or more processors 220 can include single or multiple core devices including a microprocessor, microcontroller, integrated circuit, and/or a logic device.

The network interface 222 can support network communications. For example, the network interface 222 can support communication via networks including a local area network and/or a wide area network (e.g., the Internet). Further, the network interface 222 can be used to receive data (e.g., context data) from other computing devices. The one or more mass storage devices 224 (e.g., a hard disk drive and/or a solid-state drive) can be used to store data including the content data 203, the context data 204, the input data 205, the generative audio data 206, and/or the one or more machine-learned models 207.

The one or more output devices 226 can include one or more display devices (e.g., LCD display, OLED display, Mini-LED display, microLED display, plasma display, and/or CRT display), one or more light sources (e.g., LEDs), one or more audio output devices (e.g., one or more loudspeakers), and/or one or more haptic output devices (e.g., one or more devices that are configured to generate vibratory output). For example, the one or more output devices 226 can comprise a touch sensitive display that is used to output an interface (e.g., a user interface) that can be configured to display indications based on the content data 203, the context data 204, the input data 205, and/or the generative audio data 206,.

The one or more sensors 228 can comprise one or more LiDAR devices, one or more sonar devices, one or more radar devices, one or more accelerometers, one or more gyroscopes, one or more altimeters, and/or one or more temperature sensors (e.g., one or more thermometers). The one or more input devices 230 can include one or more keyboards, one or more touch sensitive devices (e.g., a touch screen display), one or more buttons (e.g., a power button and/or volume buttons), one or more microphones, and/or one or more imaging devices (e.g., one or more cameras).

The one or more memory devices 202 and the one or more mass storage devices 224 are illustrated separately, however, the one or more memory devices 202 and the one or more mass storage devices 224 can be regions within the same memory module. The computing device 200 can include one or more additional processors, memory devices, and/or network interfaces, which can be provided separately or on the same chip or board. The one or more memory devices 202 and the one or more mass storage devices 224 can include one or more computer-readable media, including, but not limited to, non-transitory computer-readable media, RAM, ROM, hard drives, flash drives, and/or other memory devices.

The one or more memory devices 202 can store sets of instructions for applications including an operating system that can be associated with various software applications or data. For example, the one or more memory devices 202 can store sets of instructions for applications that can generate output that can include the input data 205. The one or more memory devices 202 can be used to operate various applications including a mobile operating system developed specifically for mobile devices. As such, the one or more memory devices 202 can store instructions that allow the software applications to access data including data associated with the processing of the content data 203, processing of the context data 204, processing of the input data 205, implementation of machine-learned models 207, and/or the generation of the generative audio data 206. In other embodiments, the one or more memory devices 202 can be used to operate or execute a general-purpose operating system that operates on both mobile and stationary devices, including for example, smartphones, laptop computing devices, tablet computing devices, and/or desktop computers.

The software applications that can be operated or executed by the computing device 200 can include applications associated with the systems and/or device shown in FIG. 16. Further, the software applications that can be operated and/or executed by the computing device 200 can include native applications and/or web-based applications.

The location device 232 can include one or more devices or circuitry for determining the position of the computing device 200. For example, the location device 232 can determine an actual and/or relative position of the computing device 200 by using a satellite navigation positioning system (e.g., a GPS system, a Galileo positioning system, the GLObal Navigation satellite system (GLONASS), and/or the BeiDou Satellite Navigation and Positioning system), an inertial navigation system, a dead reckoning system, based on IP address, by using triangulation and/or proximity to cellular towers and/or Wi-Fi hotspots.

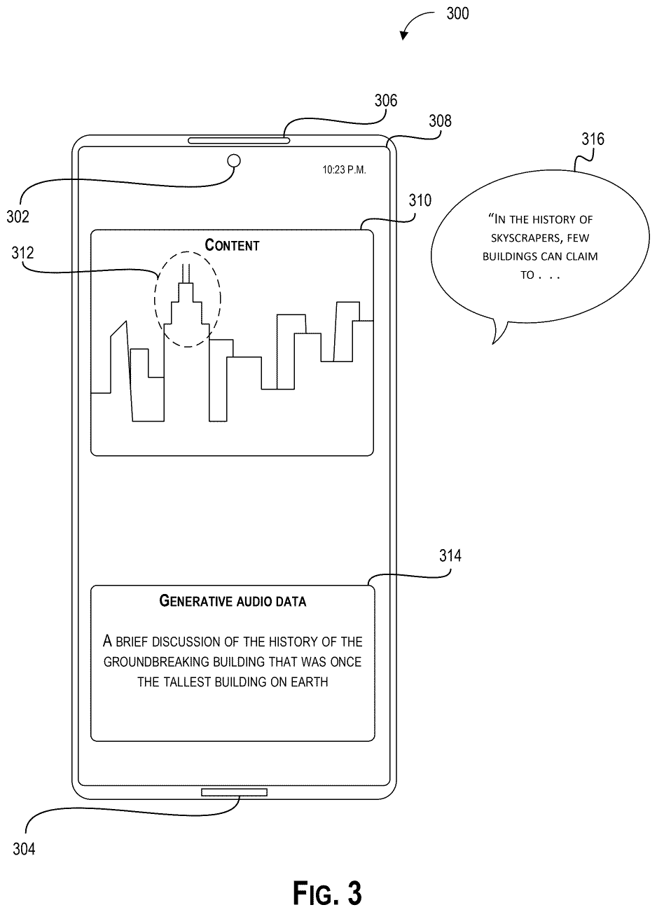

FIG. 3 depicts an example of an interface for processing generative audio data based on selection of a portion of an image according to example embodiments of the present disclosure. A computing device 300 can include one or more features and/or capabilities of the computing device 50, the server computing system 60, the model development platform system 70, and/or the computing device 200.

The computing device 300 can include an imaging device 302, an audio input device 304, an audio output device 306, a display device 308, content 310, an input 312, generative audio data 314, and/or synthetic language audio segments 316.

The computing device 300 can be configured to perform one or more operations comprising sending, receiving, processing, and/or generating data comprising content data (e.g., content data associated with the content 310), context data (e.g., context data associated with the content 310), input data (e.g., input data associated with the input 312), the generative audio data 314, the synthetic language audio segments 316, and/or other data received, stored, or generated by the computing device 300. In some embodiments, the imaging device 302 can be used to capture an image that can be used as content. For example, the imaging device 302 can be used to capture an image of a building that is part of a city skyline that can be used as content to generate the generative audio data 314 and/or the synthetic language audio segments 316.

In this example, the computing device 300 has received the content 310 which comprises an image of a city skyline that includes several buildings. In some embodiments, the content 310 can be associated with and/or comprise context (not shown) that is associated with the content 310 and/or the input 412. For example, the context can comprise location data that is included in the content 310 and which indicates the location from which the image was captured.

The input 312 comprises an indication (e.g., an ellipsoid) that indicates a portion of the content 310 that was selected. In some embodiments, the input 312 can be provided via a tactile input device (e.g., a touchscreen associated with the display device 308) that can be used to select an object (e.g., the building indicated in FIG. 3) and/or the audio input device 304 (e.g., a microphone). Further, the computing device 300 can be configured to recognize (e.g., the computing device 300 can perform speech recognition operations to recognize speech that is detected) an input 312 that is provided via the audio input device 304.

The computing device 300 can use content data (e.g., content data comprising and/or based on the content 310), context data (e.g., context data associated with the content 310 and/or the input 312), and/or the input 312 as input to one or more machine-learned models that can be implemented on the computing device 300 and/or a remote computing system that is configured to send data to and/or receive data from the computing device 300. The one or more machine-learned models can be configured and/or trained to classify, detect, and/or recognize one or more features of the content data, the context data, and/or the input 312. For example, the one or more machine-learned models can perform object recognition operations to recognize the object in the content 310 that is selected by the input 312. For example, the one or more machine-learned models can determine the name and/or history (e.g., construction history and/or architect) associated with the building indicated in the content 310. Further, the one or more machine-learned models can determine that the input 312 has been used to select a portion (e.g., a relevant portion) of the content 310.

The one or more machine-learned models can also use the context including the portions of the content that was read to generate the generative audio data 314. For example, the one or more machine-learned models can generate the generative audio data 314 based on the location data that indicates a geographic region associated with the image in the content 310. The one or more machine-learned models can then use the content features, context features, and/or input features that were processed to generate the generative audio data 314 which comprises a discussion of the topics in the content 310. The generative audio data 314 indicates “A BRIEF DISCUSSION OF THE HISTORY OF THE GROUNDBREAKING BUILDING THAT WAS ONCE THE TALLEST BUILDING IN THE WORLD.” Based on the generative audio data 314, the computing device 300 can generate the synthetic language audio segments 316 which includes the indication “IN THE HISTORY OF SKYSCRAPERS, FEW CAN CLAIM TO . . . ” The synthetic language audio segments 316 can be generated via the audio output device 306 (e.g., a loudspeaker).

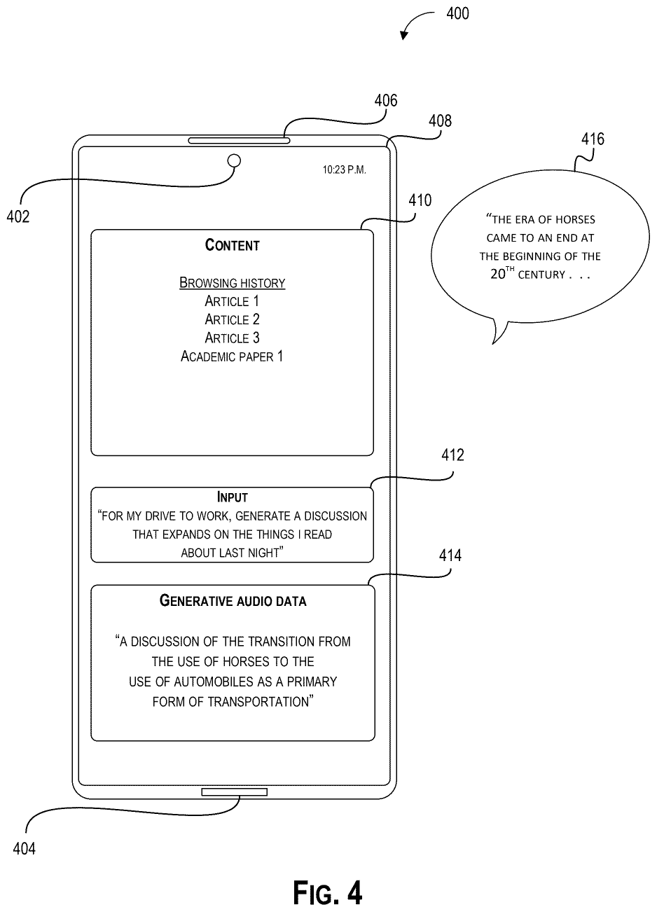

FIG. 4 depicts an example of an interface for processing generative audio data based on a browsing history according to example embodiments of the present disclosure. A computing device 400 can include one or more features and/or capabilities of the computing device 50, the server computing system 60, the model development platform system 70, and/or the computing device 200.

The computing device 400 can include an imaging device 402, an audio input device 404, an audio output device 406, a display device 408, content 410, an input 412, generative audio data 414, and/or synthetic language audio segments 416.

The computing device 400 can be configured to perform one or more operations comprising sending, receiving, processing, and/or generating data comprising content data (e.g., content data associated with the content 410), context data (e.g., context data associated with the content 410), input data (e.g., input data associated with the input 412), the generative audio data 414, the synthetic language audio segments 416, and/or other data received, stored, or generated by the computing device 400. In some embodiments, the imaging device 402 can be used to capture an image that can be used as content. For example, the imaging device 402 can be used to capture an image of a news article (e.g., a news article displayed on another computing device) that can be used as content to generate the generative audio data 414 and/or the synthetic language audio segments 416.

In this example, the computing device 400 has received the content 410 which comprises a browsing history of a user of the computing device 400. The browsing history comprises “ARTICLE 1,” “ARTICLE 2,” “ARTICLE 3,” and “ACADEMIC PAPER 1.” In some embodiments, the content 410 can be associated with and/or comprise context (not shown) that is associated with the content 410 and/or the input 412. For example, the context can comprise the websites from which the content (e.g., the articles and/or academic paper) was retrieved, the times at which the content was retrieved, and/or the portions of the content that were accessed and/or consumed (e.g., the pages of the academic paper that were opened and/or hyperlinks of the articles that were selected).

The input 412 includes the indication “FOR MY DRIVE TO WORK, GENERATE A DISCUSSION THAT EXPANDS ON THE THINGS I READ ABOUT LAST NIGHT.” In some embodiments, the input 412 can be provided via a tactile input device (e.g., an onscreen keyboard that is displayed on the display device 408) and/or the audio input device 404 (e.g., a microphone). Further, the computing device 400 can be configured to recognize the input 412 that is provided via the audio input device 404.

The computing device 400 can use content data (e.g., content data comprising and/or based on the content 410), context data (e.g., context data associated with the content 410 and/or the input 412), and/or the input 412 as input to one or more machine-learned models that can be implemented on the computing device 400 and/or a remote computing system that is configured to send data to and/or receive data from the computing device 400. The one or more machine-learned models can be configured and/or trained to classify, detect, and/or recognize one or more features of the content data, the context data, and/or the input 412. For example, the one or more machine-learned models can perform natural language processing operations to parse the input 412 and the content 410. For example, the one or more machine-learned models can determine that the content comprises articles and an academic paper about transportation at the turn of the twentieth century.

The one or more machine-learned models can also use the context including the browsing history to generate the generative audio data 414. For example, the one or more machine-learned models can generate the generative audio data 414 based on external content (e.g., another academic paper about the same topic) that is associated with the content 410. The one or more machine-learned models can then use the content features, context features, and/or input features that were processed to generate the generative audio data 414 which comprises a discussion of the topics in the content 410. The generative audio data 414 indicates “A DISCUSSION OF THE TRANSITION FROM THE USE OF HORSES TO THE USE OF AUTOMOBILES AS A PRIMARY FORM OF TRANSPORTATION.” Based on the generative audio data 414, the computing device 400 can generate the synthetic language audio segments 416 which includes the indication “THE ERA OF HORSES CAME TO AN END AT THE BEGINNING OF THE 20^{TH} CENTURY . . . ” The synthetic language audio segments 416 can be generated via the audio output device 406 (e.g., a loudspeaker).

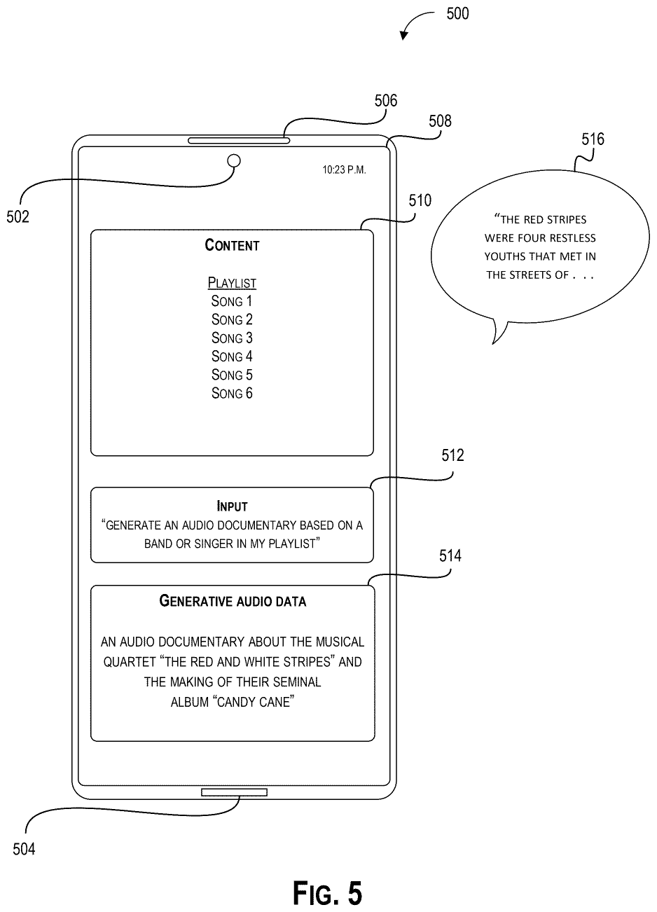

FIG. 5 depicts an example of an interface for processing generative audio data based on a playlist according to example embodiments of the present disclosure. A computing device 500 can include one or more features and/or capabilities of the computing device 50, the server computing system 60, the model development platform system 70, and/or the computing device 200.

The computing device 500 can include an imaging device 502, an audio input device 504, an audio output device 506, a display device 508, content 510, an input 512, generative audio data 514, and/or synthetic language audio segments 516.

The computing device 500 can be configured to perform one or more operations comprising sending, receiving, processing, and/or generating data comprising content data (e.g., content data associated with the content 510), context data (e.g., context data associated with the content 510), input data (e.g., input data associated with the input 512), the generative audio data 514, the synthetic language audio segments 516, and/or other data received, stored, or generated by the computing device 500.

In this example, the computing device 500 has received the content 510 which comprises a playlist of a user of the computing device 500. The playlist can be displayed within a web browser or a music playback application. The playlist comprises a plurality of songs including “SONG 1,” “SONG 2,” “SONG 3,” “SONG 4,” “SONG 5,” and “SONG 6.” In some embodiments, the content 510 can be associated with and/or comprise context (not shown) that is associated with the content 510 and/or the input 412. For example, the context can comprise the names of other songs that were played recently and/or the times at which the songs were played.

The input 512 indicates “GENERATE AN AUDIO DOCUMENTARY BASED ON A BAND OR SINGER IN MY PLAYLIST.” In some embodiments, the input 512 can be provided via a tactile input device (e.g., an onscreen keyboard that is displayed on the display device 508) and/or the audio input device 504 (e.g., a microphone). Further, the computing device 500 can be configured to recognize the input 512 that is provided via the audio input device 504.

The computing device 500 can use content data (e.g., content data comprising and/or based on the content 510), context data (e.g., context data associated with the content 510 and/or the input 512), and/or the input 512 as input to one or more machine-learned models that can be implemented on the computing device 500 and/or a remote computing system that is configured to send data to and/or receive data from the computing device 500. The one or more machine-learned models can be configured and/or trained to classify, detect, and/or recognize one or more features of the content data, the context data, and/or the input 512. For example, the one or more machine-learned models can perform natural language processing operations to parse the input 512 and the content 510. For example, the one or more machine-learned models can determine that the content comprises songs about particular bands and/or singers and that the input is requesting a documentary about one of the bands of singers.

The one or more machine-learned models can also use the context including other songs that were recently played. For example, the one or more machine-learned models can generate the generative audio data 514 based on a band or singer in the playlist that matches a recently played song by the same band or singer. The one or more machine-learned models can then use the content features, context features, and/or input features that were processed to generate the generative audio data 514 which comprises a documentary based on the content 510. The generative audio data 514 indicates “AN AUDIO DOCUMENTARY ABOUT THE MUSICAL QUARTET ‘THE RED STRIPES’ AND THE MAKING OF THEIR SEMINAL ‘ALBUM CANDY CANE.” Based on the generative audio data 514, the computing device 500 can generate the synthetic language audio segments 516 which includes the indication “THE RED STRIPES WERE FOUR RESTLESS YOUTHS THAT MET IN THE STREETS OF . . . ” The synthetic language audio segments 516 can be generated via the audio output device 506 (e.g., a loudspeaker).

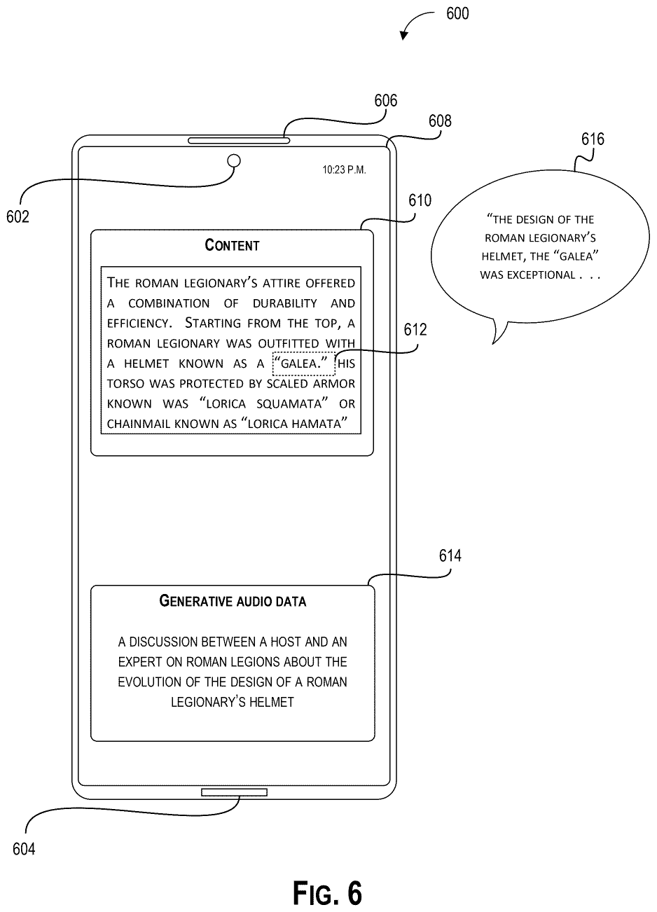

FIG. 6 depicts an example of an interface for processing generative audio data based on selection of a portion of text according to example embodiments of the present disclosure. A computing device 600 can include one or more features and/or capabilities of the computing device 50, the server computing system 60, the model development platform system 70, and/or the computing device 200.

The computing device 600 can include an imaging device 602, an audio input device 604, an audio output device 606, a display device 608, content 610, an input 612, generative audio data 614, and/or synthetic language audio segments 616.

The computing device 600 can be configured to perform one or more operations comprising sending, receiving, processing, and/or generating data comprising content data (e.g., content data associated with the content 610), context data (e.g., context data associated with the content 610), input data (e.g., input data associated with the input 612), the generative audio data 614, the synthetic language audio segments 616, and/or other data received, stored, or generated by the computing device 600.

In this example, the computing device 600 has received the content 610 which comprises an article about the attire worn by Roman legionaries. The article indicates “THE ROMAN LEGIONARY'S ATTIRE OFFERED A COMBINATION OF DURABILITY AND EFFICIENCY. STARTING FROM THE TOP, A ROMAN LEGIONARY WAS OUTFITTED WITH A HELMET KNOWN AS A ‘GALEA.’ HIS TORSO WAS PROTECTED BY SCALED ARMOR KNOWN AS ‘LORICA SQUAMATA’ OR CHAINMAIL KNOWN AS ‘LORICA HAMATA.” In some embodiments, the content 610 can be associated with and/or comprise context (not shown) that is associated with the content 610 and/or the input 412. For example, the context can comprise the document repository from which the content (e.g., the article) was retrieved, the times at which the content was retrieved, and/or the portions of the content that were accessed and/or consumed.

The input 612 comprises an indication (e.g., a rectangular selection or highlighting of text) that indicates a portion of the content 610 that was selected. In some embodiments, the input 612 can be provided via a tactile input device (e.g., a touchscreen associated with the display device 608) that can be used to select an object (e.g., the building indicated in FIG. 6) and/or the audio input device 604 (e.g., a microphone).

The computing device 600 can use content data (e.g., content data comprising and/or based on the content 610), context data (e.g., context data associated with the content 610 and/or the input 612), and/or the input 612 as input to one or more machine-learned models that can be implemented on the computing device 600 and/or a remote computing system that is configured to send data to and/or receive data from the computing device 600. The one or more machine-learned models can be configured and/or trained to classify, detect, and/or recognize one or more features of the content data, the context data, and/or the input 612. For example, the one or more machine-learned models can perform natural language processing operations to parse the input 612 and the content 610. For example, the one or more machine-learned models can determine that the content 610 comprises an article about Roman legionaries. Further, the one or more machine-learned models can determine that the word “GALEA” was selected based on the input 312. Selection of the word can indicate a significance and/or relevance of the word and concepts associated with the word can feature prominently in the generative audio data 614.

The one or more machine-learned models can also use the context including the portions of the content that was read to generate the generative audio data 614. The one or more machine-learned models can then use the content features, context features, and/or input features that were processed to generate the generative audio data 614 which comprises a discussion of the topics in the content 610. The generative audio data 614 indicates “A DISCUSSION BETWEEN A HOST AND AN EXPERT ON ROMAN LEGIONS ABOUT THE EVOLUTION OF THE DESIGN OF A ROMAN LEGIONARY'S HELMET.” Based on the generative audio data 614, the computing device 600 can generate the synthetic language audio segments 616 which includes the indication “THE DESIGN OF THE ROMAN LEGIONARY'S HELMET, THE ‘GALEA’ WAS EXCEPTIONAL. .” The synthetic language audio segments 616 can be generated via the audio output device 606 (e.g., a loudspeaker).

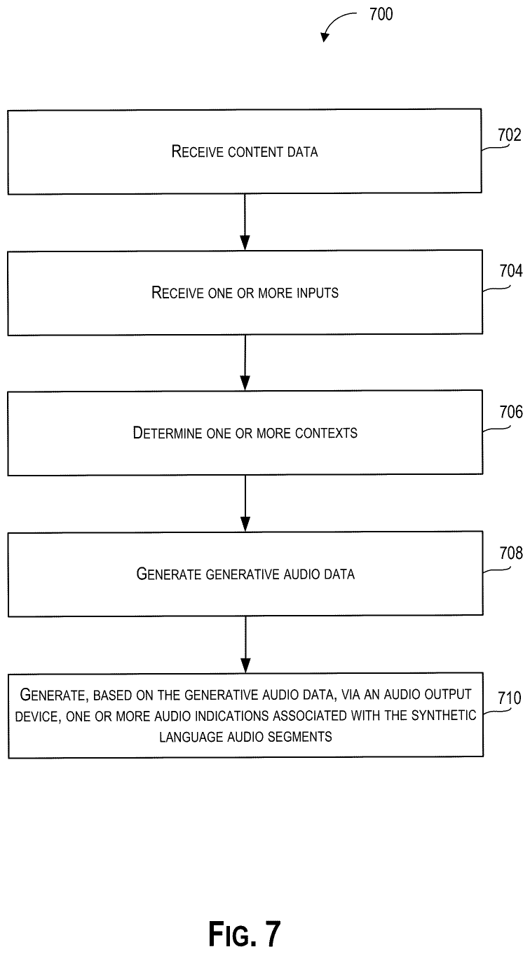

FIG. 7 depicts a flow chart diagram of an example method of processing generative audio according to example embodiments of the present disclosure. One or more portions of the method 700 can be executed and/or implemented on one or more computing devices or computing systems comprising, for example, the computing device 50, the server computing system 60, the model development platform system 70, and/or the computing device 200. Further, one or more portions of the method 700 can be executed or implemented as an algorithm on the hardware devices or systems disclosed herein. FIG. 7 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 702, the method 700 can include receiving content data associated with content comprising one or more content modalities. For example, the server computing system 60 can receive, via a network such as the network 49, content data comprising a document (e.g., a news article) that includes text and/or images. In some embodiments, the content data can comprise a reference to content (e.g., a link to a webpage).

At 704, the method 700 can include receiving one or more inputs associated with the content. For example, the one or more inputs can comprise a tactile input associated with selecting a portion of an image of a bird, by encircling the portion of the image that includes the bird. By way of further example, the server computing system 60 can receive data comprising one or more text-based inputs (e.g., a text-based input comprising a prompt that can be processed by one or more machine-learned models) via a text-input device and/or one or more voice-based inputs (e.g., voice-based inputs that can be recognized by a computing system and used as an input to one or more machine-learned models) via a microphone. The one or more inputs can be received from a local device and/or from a remote source via a network such as the network 49.

At 706, the method 700 can include determining one or more contexts associated with the content and/or the one or more inputs. For example, the server computing system 60 can access data comprising a search history and/or webpages visited by a user of the computing device 50 (e.g., a smartphone). The search history and/or web pages can be used to determine the one or more contexts associated with the content and/or the one or more inputs. For example, if the content data comprises an image of a Roman legionary and the one or more contexts comprise webpages directed to Roman history, the one or more contexts can comprise the webpages that are directed to Roman history.

At 708, the method 700 can include generating, based on inputting the content data, context data associated with the one or more contexts, and/or input data associated with the one or more inputs into one or more machine-learned models, generative audio data comprising one or more synthetic language audio segments associated with the content data, the context data, and/or the input data. The one or more machine-learned models can be configured to generate the generative audio based on processing one or more features of the content data, the context data, and/or the input data. For example, the server computing system 60 can implement one or more machine-learned models that are configured and/or trained to generate the generative audio data based on context data comprising one or more text segments from web pages associated with content comprising an image.

At 710, the method 700 can include generating, based on the generative audio data, via an audio-output device, the one or more synthetic language audio segments associated with the generative audio data. For example, the server computing system 60 can generate one or more synthetic language audio segments that narrate a story about a Roman legionary that was separated from his Legion and established what became a prominent town in a faraway land. The server computing device can then send the generative audio data to the computing device 50. The one or more synthetic language audio segments can then be outputted through an audio-output device (e.g., loudspeakers) of the computing device 50 (e.g., a smartphone)

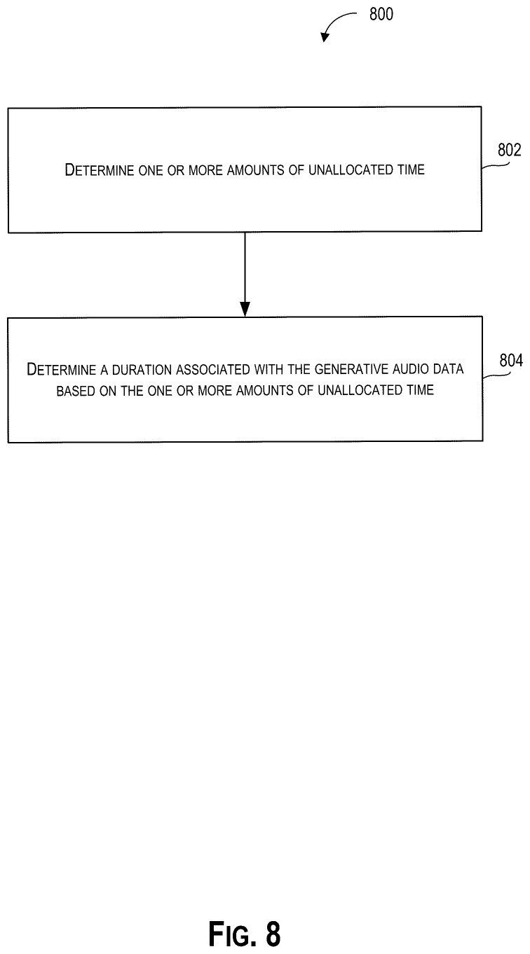

FIG. 8 depicts a flow chart diagram of an example method of processing generative audio according to example embodiments of the present disclosure. One or more portions of the method 800 can be executed and/or implemented on one or more computing devices or computing systems comprising, for example, the computing device 50, the server computing system 60, the model development platform system 70, and/or the computing device 200. Further, one or more portions of the method 800 can be executed or implemented as an algorithm on the hardware devices or systems disclosed herein. In some embodiments, one or more portions of the method 800 can be performed as part of the method 700 that is described with respect to FIG. 7. FIG. 8 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 802, the method 800 can include determining, based on the context data, one or more amounts of unallocated time that are available to a user associated with the one or more inputs. For example, the server computing system 60 can access context data based on one or more contexts comprising information from a navigation application associated with a user's computing device. The context data can be used to determine the location (e.g., a current location of the computing device 50) and a destination of the user that operates the computing device 50 (e.g., a smartphone). The server computing system 60 can then determine an amount of unallocated time available to the user based on a determination of the estimated amount of time to travel from the location to the destination.

At 804, the method 800 can include determining a duration associated with the generative audio data based on the one or more amounts of unallocated time. For example, if the server computing device 60 determined that the amount of unallocated time is forty-five minutes, the server computing device 60 can generate generative audio that has a duration of forty-five minutes.

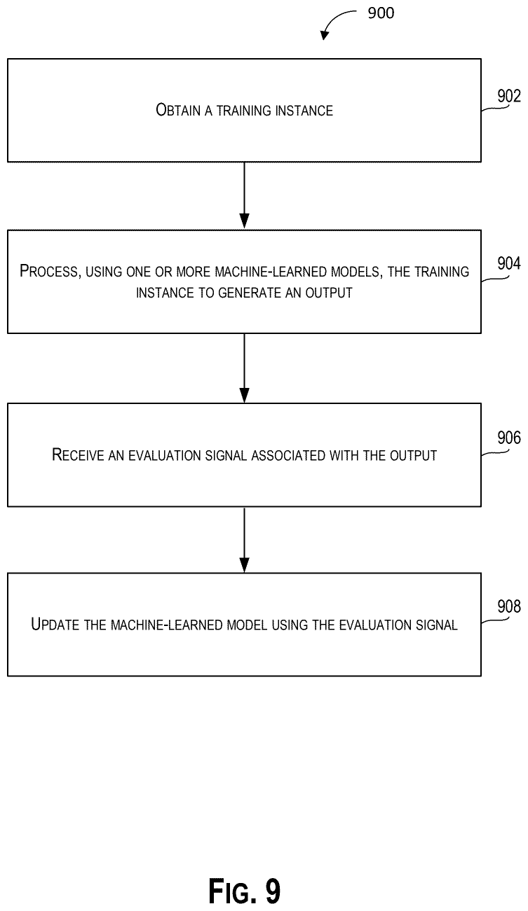

FIG. 9 depicts a flowchart of a method for training one or more machine-learned models according to aspects of the present disclosure. For instance, an example machine-learned model can process input including content data, context data, and/or input data. Further, the machine-learned model can be configured and/or trained to generate generative audio based on the input.

One or more portion(s) of example method 900 can be implemented by a computing system that includes one or more computing devices such as, for example, computing systems described with reference to the other figures. Each respective portion of example method 900 can be performed by any (or any combination) of one or more computing devices. Moreover, one or more portion(s) of example method 900 can be implemented on the hardware components of the device(s) described herein, for example, to train one or more systems or models. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 9 is described with reference to elements/terms described with respect to other systems and figures for exemplary illustrated purposes and is not meant to be limiting. One or more portions of example method 900 can be performed additionally, or alternatively, by other systems.

At 902, example method 900 can include obtaining a training instance. A set of training data can include a plurality of training instances divided between multiple datasets (e.g., a training dataset, a validation dataset, or testing dataset). A training instance can be labeled or unlabeled. Although referred to in example method 900 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure. For example, the training instance can comprise a variety of historical queries that are associated with various context items.

At 904, example method 900 can include processing, using one or more machine-learned models, the training instance to generate an output. The output can be directly obtained from the one or more machine-learned models or can be a downstream result of a chain of processing operations that includes an output of the one or more machine-learned models.

At 906, example method 900 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 908, example method 900 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 900 can include implementing a number of generalization techniques (e.g., weight decays, dropouts, etc.) to improve the generalization capability of the models being trained.

In some implementations, example method 900 can be implemented for training a machine-learned model from an initialized state to a fully trained state (e.g., when the model exhibits a desired performance profile, such as based on accuracy, precision, recall, etc.).

In some implementations, example method 900 can be implemented for particular stages of a training procedure. For instance, in some implementations, example method 900 can be implemented for pre-training a machine-learned model. Pre-training can include, for instance, large-scale training over potentially noisy data to achieve a broad base of performance levels across a variety of tasks/data types.

In some implementations, the example method 900 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 900 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 900 can be implemented to execute parameter-efficient fine-tuning methods, such as Low-Rank Adaptation (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

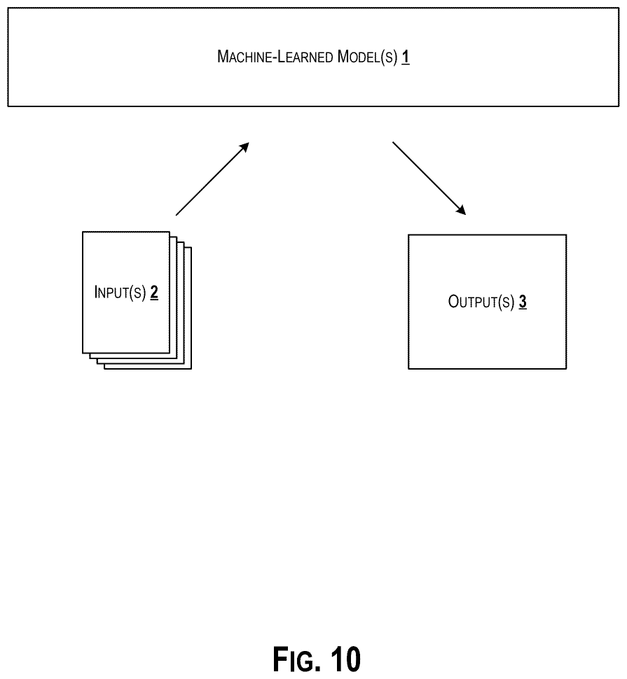

FIG. 10 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be, include, or otherwise be representative of any one or more of the machine-learned models described above with respect to the preceding figures. For example, machine-learned model(s) 1 can be or include, or otherwise be representative of any one or more of the machine-learned models described herein. Although various features, variations, and implementations described below are described with respect to machine-learned model(s) 1, it is to be understood that such features, variations, and implementations are to be understood as described with respect to each of the machine-learned components described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, arXiv: 2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

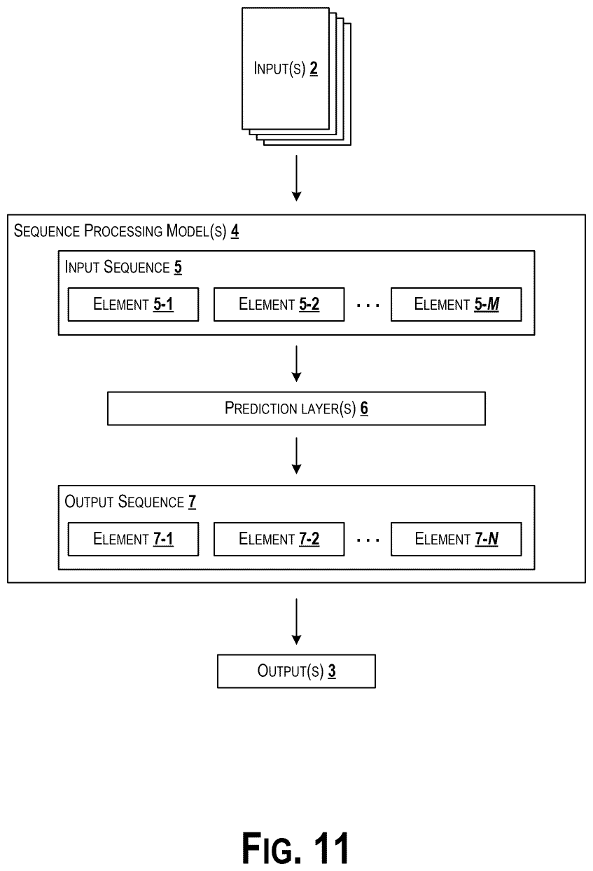

FIG. 11 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Large Language Models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, Google; and/or Gemma 2: Improving Open Language Models at a Practical Size, Google.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, Google; PaliGemma 2: A Family of Versatile VLMs for Transfer, Google; Flamingo: a Visual Language Model for Few-Shot Learning, Google; and/or PaLI: A Jointly-Scaled Multilingual Language-Image Model, Google.

Sequence processing model(s) 4 can be multimodal. Example multimodal sequence processing models include, for instance, models described in Gemini: A Family of Highly Capable Multimodal Models, Google; Gemini 1.5: Unlocking multimodal understanding across millions of tokens of context, Google.

Other example sequence processing models can operate to generate outputs or receive inputs in specific domains, such as image domains, see, e.g., Dosovitskiy et al., An Image is Worth 16×16 Words: Transformers for Image Recognition at Scale, arXiv: 2010.11929v2 (Jun. 3, 2021), audio domains, see, e.g., Agostinelli et al., MusicLM: Generating Music From Text, arXiv: 2301.11325v1 (Jan. 26, 2023), biochemical domains, see, e.g., Jumper et al., Highly accurate protein structure prediction with AlphaFold, 596 Nature 583 (Aug. 26, 2021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (October 31-Nov. 4, 2018). Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 11 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv: 1706.0376v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

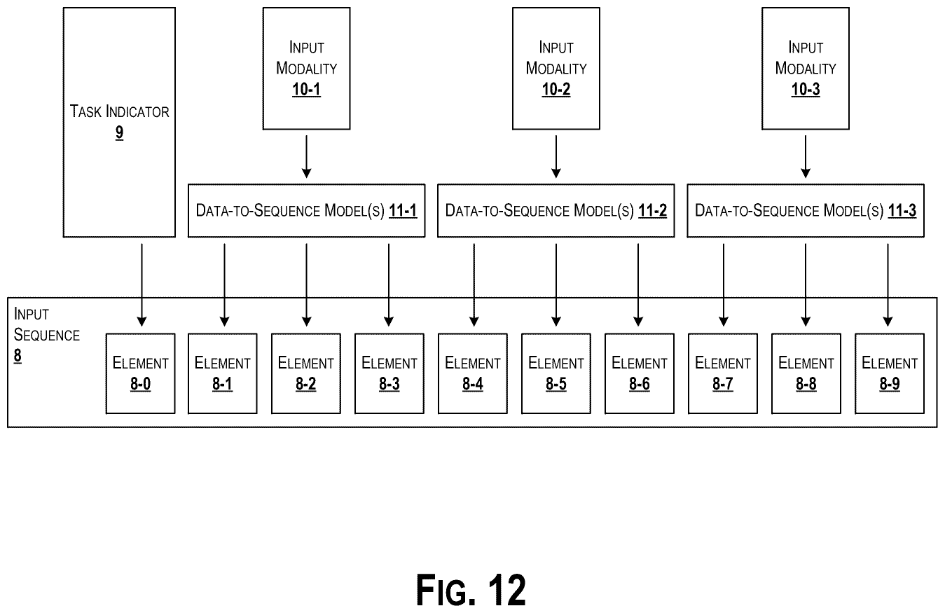

FIG. 12 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

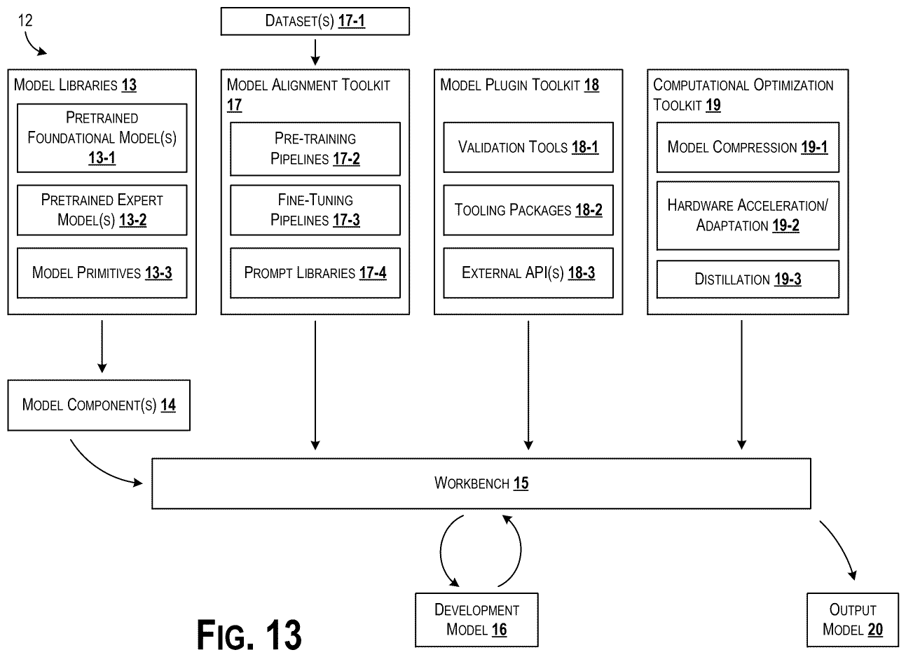

FIG. 13 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 700 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

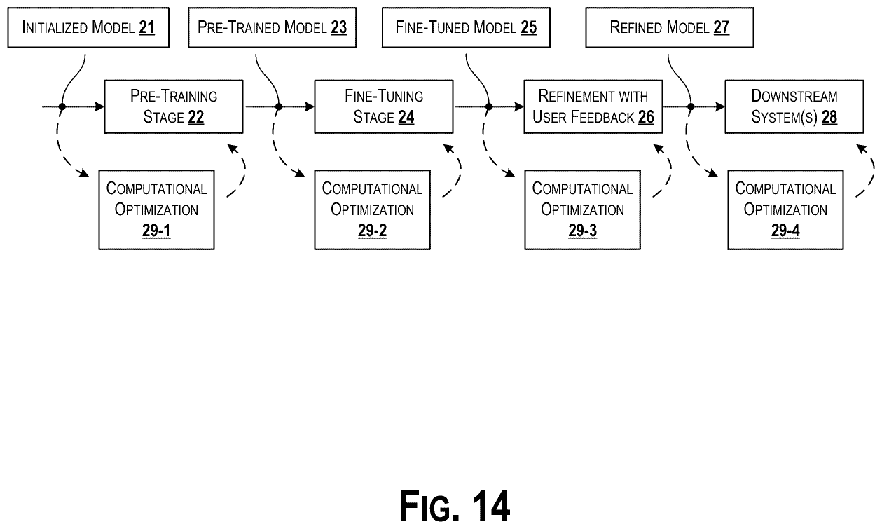

FIG. 14 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 14 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 14 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

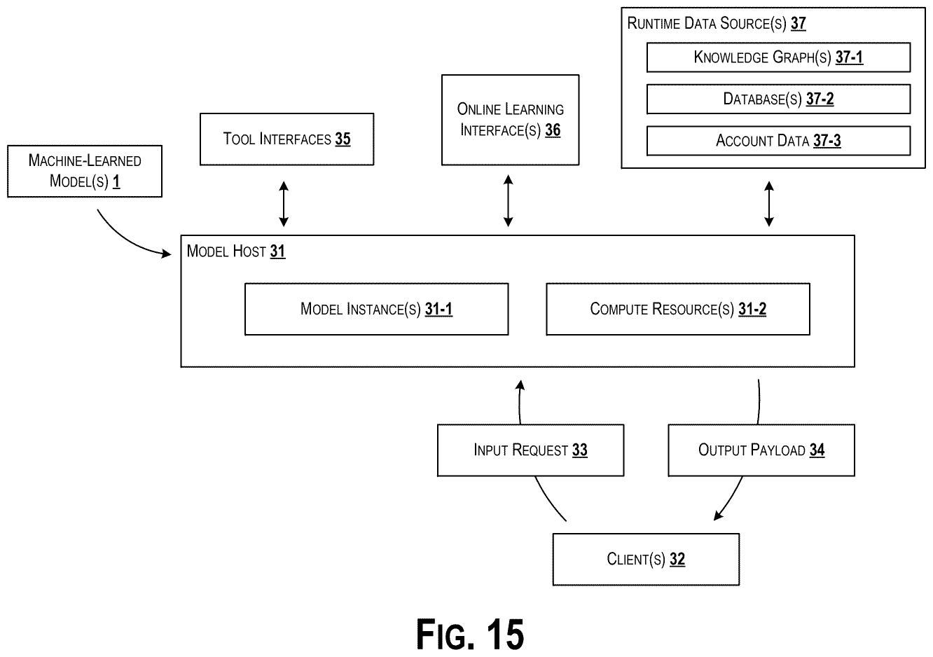

FIG. 15 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external, or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

FIG. 16 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 16 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and/or combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 16 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

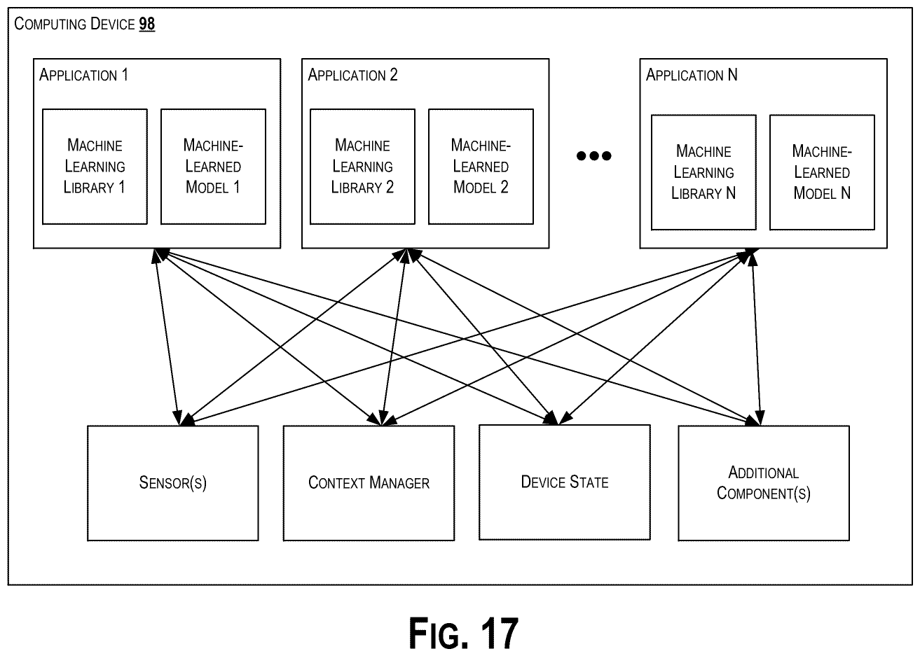

FIG. 17 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 17, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

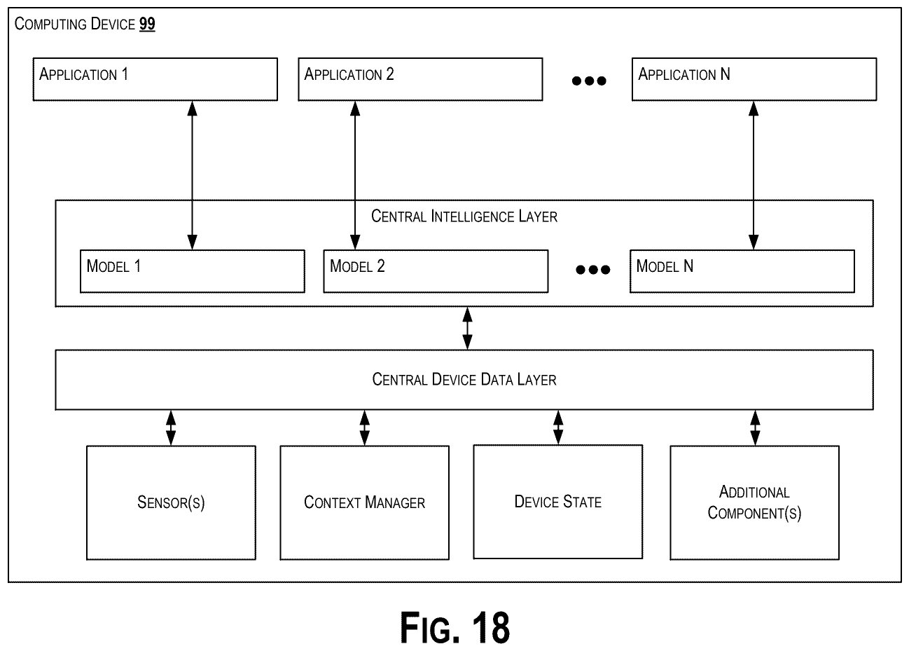

FIG. 18 is a block diagram of an example computing device 99 that performs according to example embodiments of the present disclosure. The computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 18, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 18, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of,” “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method of processing generative audio content, the computer-implemented method comprising:
receiving, by a computing system comprising one or more processors, content data associated with content comprising one or more content modalities;
receiving, by the computing system, one or more inputs associated with the content;
determining, by the computing system, one or more contexts associated with the content or the one or more inputs;
generating, by the computing system, based on inputting the content data, context data associated with the one or more contexts, and input data associated with the one or more inputs into one or more machine-learned models, generative audio data comprising one or more synthetic language audio segments associated with the content data, the context data, and the input data, wherein the one or more machine-learned models are configured to generate the generative audio based on processing one or more features of the content data and the context data; and
generating, by the computing system, based on the generative audio data, via an audio-output device, one or more audio indications associated with the one or more synthetic language audio segments.

2. The computer-implemented method of claim 1, wherein the one or more machine-learned models are configured to classify, detect, or recognize one or more objects in the content data, and wherein generating the generative audio data is based in part on detection, recognition, or classification of the one or more objects in the content data.

3. The computer-implemented method of claim 1, wherein the one or more machine-learned models comprise one or more retrieval augmented generation (RAG) models that are configured to perform one or more searches of one or more content sources based on the content data, the context data, or the input data, wherein the one or more machine-learned models are further configured to retrieve additional content data that is based on the one or more searches and not included in the content data, and wherein the one or more machine-learned models are further configured to generate the generative audio data based in part on the additional content data.

4. The computer-implemented method of claim 1, wherein the one or more contexts comprise an application associated with the content data, a search history, one or more locations associated with the content data or the context data, or one or more time intervals associated with the content data or the context data.

5. The computer-implemented method of claim 1, further comprising:
determining, by the computing system, based on the context data, one or more amounts of unallocated time that are available to a user associated with the one or more inputs; and
determining, by the computing system, a duration associated with the generative audio data based on the one or more amounts of unallocated time.

6. The computer-implemented method of claim 5, wherein the context data comprises a schedule of the user or one or more indications of an estimated travel time of the user from an initial location to a destination.

7. The computer-implemented method of claim 1, wherein the one or more inputs comprise one or more text-based prompts associated with the content data, and wherein the one or more machine-learned models are further configured to generate the generative audio data based on detection, recognition, or classification of one or more features of the one or more text-based prompts.

8. The computer-implemented method of claim 1, wherein the one or more inputs comprise one or more tactile inputs associated with one or more portions of the content data comprising an image displayed on a display device configured to display the content, and wherein the one or more machine-learned models are further configured to generate the generative audio data based on detection, recognition, or classification of one or more features of the one or more portions of the content data associated with the one or more tactile inputs.

9. The computer-implemented method of claim 8, wherein the one or more tactile inputs comprise tapping the one or more portions of the content data comprising the image displayed on a display device, encircling the one or more portions of the content data comprising the image displayed on the display device, or swiping the one or more portions of the content data comprising the image displayed on the display device.

10. The computer-implemented method of claim 1, wherein the one or more inputs comprise one or more speech-based prompts associated with the content data, and wherein the one or more machine-learned models are further configured to generate the generative audio data based on detection, recognition, or classification of one or more features of the one or more speech-based prompts.

11. The computer-implemented method of claim 1, wherein the content data comprises content from a plurality of different time intervals or content associated with a plurality of different search sessions.

12. The computer-implemented method of claim 1, wherein the one or more machine-learned models are configured to determine a tone, tempo, or reading comprehension level of the generative audio data based on the content data, the context data, or the one or more inputs, and wherein the one or more machine-learned models are configured to generate the generative audio data based on the tone, the tempo, or the reading comprehension level of the content data, the context data, or the input data.

13. The computer-implemented method of claim 1, wherein the content data comprises one or more images, one or more text segments, one or more audio segments, one or more video segments, or one or more audio-video segments.

14. The computer-implemented method of claim 1, wherein the one or more machine-learned models comprise one or more transformer models or one or more autoencoder models.

15. The computer-implemented method of claim 1, wherein the generative audio data comprises one or more podcasts associated with the content data, the context data, or the input data.

16. One or more tangible non-transitory computer-readable media storing computer-readable instructions that when executed by one or more processors cause the one or more processors to perform operations, the operations comprising:
receiving content data associated with content comprising one or more content modalities;
receiving one or more inputs associated with the content;
determining one or more contexts associated with the content or the one or more inputs;
generating, based on inputting the content data, context data associated with the one or more contexts, and input data associated with the one or more inputs into one or more machine-learned models, generative audio data comprising one or more synthetic language audio segments associated with the content data, the context data, and the input data, wherein the one or more machine-learned models are configured to generate the generative audio based on processing one or more features of the content data and the context data; and
generating, based on the generative audio data, via an audio-output device, one or more audio indications associated with the one or more synthetic language audio segments.

17. The one or more tangible non-transitory computer-readable media of claim 16, wherein the one or more machine-learned models are configured to perform one or more searches based on the content data or the context data, wherein the one or more machine-learned models are configured to retrieve additional content data based on the one or more searches, wherein the additional content data comprises content that is not included in the content data, and wherein the one or more machine-learned models are configured to generate the generative audio based in part on the additional content data.

18. A computing system comprising:
one or more processors;
one or more non-transitory computer-readable media storing instructions that when executed by the one or more processors cause the one or more processors to perform operations comprising:
receiving content data associated with content comprising one or more content modalities;
receiving one or more inputs associated with the content;
determining one or more contexts associated with the content or the one or more inputs;
generating, based on inputting the content data, context data associated with the one or more contexts, and input data associated with the one or more inputs into one or more machine-learned models, generative audio data comprising one or more synthetic language audio segments associated with the content data, the context data, and the input data, wherein the one or more machine-learned models are configured to generate the generative audio based on processing one or more features of the content data and the context data; and
generating, based on the generative audio data, via an audio-output device, one or more audio indications associated with the one or more synthetic language audio segments.

19. The computing system of claim 18, wherein the one or more machine-learned models are configured to determine a tone, tempo, or reading comprehension level of the generative audio data based on the content data, the context data, or the one or more inputs, and wherein the one or more machine-learned models are configured to generate the generative audio data based on the tone, the tempo, or the reading comprehension level of the content data, the context data, or the input data.

20. The computing system of claim 18, wherein the one or more machine-learned models comprise one or more retrieval augmented generation (RAG) models that are configured to perform one or more searches of one or more content sources based on the content data or the context data, wherein the one or more machine-learned models are further configured to retrieve additional content data that is based on the one or more searches and not included in the content data, and wherein the one or more machine-learned models are further configured to generate the generative audio data based in part on the additional content data.
